(19) United States
(12) Patent Application Publication
(10) Pub. No.: US 2005/0122720 A1
(43) Pub. Date: Jun. 9, 2005

(54) Light source apparatus and optical communication apparatus using the same

(75) Inventors: Atsushi Shimonaka, Nara-shi (JP); Takuma Hiramatsu, Tenri-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 10/989,438

(22) Filed: Nov. 17, 2004

(30) Foreign Application Priority Data
Nov. 18, 2003 (JP) P2003-387608
Jun. 16, 2004 (JP) P2004-178328
Oct. 15, 2004 (JP) P2004-301708

(51) Int. Cl. F21V 7/04; F21S 2/00

(52) U.S. Cl. 362/257

(57) ABSTRACT

A light source apparatus is provided with a light scattering region 5 containing light scattering particles 6 disposed in a part of a region extending from a semiconductor light-emitting laser chip 1 to an external space. An asymmetry factor g of the light scattering particles 6 and a transport optical depth <n> of the light scattering region 5 are set so that their product g.<n> satisfies a following condition:
2≦g·<n>≦40 The light source apparatus is of small-size and low-cost and can ensure safety of human eyes as well as obtain a high optical output.

This Nonprovisional application claims priority under 35 U.S.C. §119(a) on Patent Applications Nos. P2003-387608 filed in Japan on Nov. 18, 2003, P2004-178328 filed in Japan on Jun. 16, 2004 and P2004-301708 filed in Japan on Oct. 15, 2004, the entire contents of which are hereby incorporated by reference.

### BACKGROUND OF THE INVENTION

The present invention relates to a light source apparatus and an optical communication apparatus using the same, and more particularly, relates to a light source apparatus applicable to the wide range of consumer technologies including optical wireless communication and light sensor application, and an optical communication apparatus using the same.

Examples of conventional light source apparatuses include one that reduces special coherence of the light emitted from a semiconductor laser device (see, e.g., JP 09-307174 A). In the light source apparatus that reduces special coherence, there is disclosed a method for reducing special coherence of the light from the semiconductor laser device with use of a diffuser. For example, as shown in FIG. 20, there is disclosed a light source apparatus that reduces special coherence of laser light by placing a diffuser 110 in an aperture of a cap 103 positioned at a certain distance from a semiconductor laser chip 101 mounted on a stem 102, and reducing the special coherence of laser light by the diffuser 110. Alternatively, as shown in FIG. 21, there is disclosed a light source apparatus in which a concave lens 111 for increasing the source size is interposed in between the semiconductor laser chip 101 and the diffuser 110.

Safety regarding lasers and light-emitting diodes is stipulated by International Safety Standard IEC60825-1. According to the standard, safety regarding eyes is basically determined by depending on the light density on the retina. More particularly, increasing a substantial source size (i.e., apparent source size; hereinbelow just referred to as “source size”) makes it possible to ensure eye safety.

However, the source size of the light source apparatuses shown in FIGS. 20 and 21 is largely dependent on the angle of radiation of the semiconductor laser chip 101. For example, in the light source apparatus shown in FIG. 20, the typical semiconductor laser chip 101 has a radiation directional half-angle in the range of ±5 degrees to ±10 degrees in horizontal direction and in the range of ±10 degrees to ±30 degrees in vertical direction with respect to an active layer which radiates laser light, and its expected source size with respect to a distance L from the semiconductor laser chip 101 to the diffuser 110 is in the range of 0.2 L to 0.4 L in horizontal direction and in the range of 0.4 L to 1.4 L in vertical direction. Since the actual source size is given as a mean value of the horizontal and vertical values, the size is limited to 0.3 L to 0.9 L. In such a case, increasing the source size requires increasing the distance L from the semiconductor laser chip 101 to the diffuser 110, causing a problem that downsizing of the light source apparatus itself is hindered. As a solution of this problem, an optical system shown in FIG. 21 has been proposed. However, in this case, a lens 111 needs to be disposed between a semiconductor laser chip 101 and a diffuser 110, which makes the apparatus even larger, and also due to another factor such as increase in the number of component parts, the optical system does not always satisfy industrial needs.

### SUMMARY OF THE INVENTION

Accordingly, an object of the present invention is to provide a small-size and low-cost light source apparatus capable of ensuring safety of human eyes and obtaining a high optical output, and an optical communication apparatus using the same.

The light source apparatus of the present invention is structured such that in a part of the region extending from the semiconductor light-emitting device to an external space where light radiated from the semiconductor light-emitting device passes, a light scattering region containing light scattering particles is disposed to provide a light scattering function, so that the light scattering region having the light scattering function has an effect of increasing the source size. In this invention, discussion is given to a selection method of light scattering particles and optimization of transport optical depth in the forming step of the light scattering region depending on the case where the light scattering particles do or do not absorb light. More specifically, in the region where light can be assumed not to be absorbed, the light scattering region is structured such that a product g·<n> of an asymmetry factor g of light scattering particles and a transport optical depth <n> of the light scattering region satisfies the following condition:
2≦g·<n>≦40

More preferably, the light scattering region is structured so as to satisfy the following condition:
2≦g·<n>≦15

Moreover, in the case where the light scattering particles absorb light, it is necessary to select light scattering particles depending on the degree of absorption (a value of albedo γ). In a light source apparatus in one embodiment, light scattering particles are selected such that when the albedo γ of the light scattering particles is 0<γ<1, the asymmetry factor g of the light scattering particles satisfies the following condition:

$$g \leq 0.342 {( \frac{1}{γ} - 1 )}^{- 0.116}$$

Further, in the light source apparatus in one embodiment, an asymmetry factor g of light scattering particles and a transport optical depth <n> of the light scattering region are so set that a product g·<n> satisfies the following condition when the albedo γ of the light scattering particles is 0<γ<1:

$$2 \leq g \cdot 〈 n 〉 \leq 0.146 {( \frac{1}{γ} - 1 )}^{- 0.487}$$

Consequently, 80% or more of the light emitted from the semiconductor light-emitting device can be introduced to, for example, an epoxy lens, and decrease in source size can be suppressed within 20% from a maximum source size.

Further, maximization of the source size is achieved by further narrowing down the range of the product g·<n>. For example, when the decrease in source size is suppressed from the maximum source size by 10%, the following condition is obtained:

$$2 \leq g \cdot 〈 n 〉 \leq 0.110 {( \frac{1}{γ} - 1 )}^{- 0.487}$$

More preferably, the light scattering region capable of permitting a maximum source size with a lower optical loss is structured by setting the transport optical depth <n> of the light scattering region by the following condition:
3≦<n>≦20

Further, in order to decrease the light optical loss, a value of the asymmetry factor g of the light scattering particles is set by the following condition, by which high optical output may be achieved.
g<0.9

Further, for accurate control of the transport optical depth of the light scattering region, a reservoir section made of a light scattering member containing light scattering particles should preferably be provided.

Further, in order to achieve the aforementioned results of g<0.9 and g·<n>>2, the light scattering particles should preferably contain particles with particle size/wavelength=0.67-1.0.

Further, in order to increase a scattering sectional area and gain an effect of increasing the source size, a difference in index of refraction between the light scattering particles and a base material needs to be not less than 0.025 times and not more than 0.043 times as large as the index of refraction of the base material, and a voluminal mixing ratio of the scattering particles to the base material needs to be less than 25%.

Further, in order to increase a scattering sectional area and gain an effect of increasing the source size and further gain an effect of decreasing the speckle, a difference in index of refraction between the light scattering particles and a base material needs to be not less than 0.043 times as large as the index of refraction of the base material, and a voluminal mixing ratio of the scattering particles to the base material needs to be less than 25%.

Moreover, the light scattering particles should preferably be made of any one of polymethyl styrene, polymethyl methacrylate and polybutyl methacrylate.

Further, an asymmetry factor g of the light scattering particles should preferably be obtained from the following formula:

$$g = {\int }_{0}^{∞} p ( r ) {g}_{i} ( r ) ⅆ r ,$$

wherein p(r) represents particle size distribution probability of the light scattering particles and gᵢ(r) represents an asymmetry factor when the particle size of the light scattering particles is r.

Further, when the light scattering region is composed of a plurality of light scattering particles, an asymmetry factor g of the light scattering particles should preferably be obtained from the following formulas:

$$\begin{matrix}g = {\sum }_{j = 1}^{n} {f}_{i} {\int }_{0}^{∞} {p}_{j} ( r ) {g}_{ji} ( r ) ⅆ r ; and \\ {\sum }_{j = 1}^{n} {f}_{i} = 1 ,\end{matrix}$$

wherein fⱼ(j=1, . . . , n (n is an integer equal to or larger than 2)) represents a ratio of the number of the light scattering particles, pⱼ(r) represents particle size distribution probability per light scattering particle, and gⱼᵢ(r) represents an asymmetry factor when the particle size of the light scattering particles is r.

Further, an optical communication apparatus of the present invention is equipped with the light source apparatus.

According to the optical communication apparatus, distance of communication can be considerably increased compared to the case where a general semiconductor laser is used, which makes it possible to provide an optical communication apparatus applicable to communication between distant locations.

As is clear from the above description, according to the light source apparatus of the present invention, a small-size and low-cost light source apparatus which ensures a sufficient effect of increasing the source size while suppressing optical loss due to scattering may be implemented by introducing a minute light scattering region.

According to the optical communication apparatus of the present invention, use of the light source apparatus makes it possible to implement a small-size and low-cost optical communication apparatus capable of expanding communication distance.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a cross sectional view showing the structure of an optical module embodying a light source apparatus in a first embodiment of the present invention;

FIG. 2 is a view showing the relation between a transport optical depth <n> and an optical output q (without absorption);

FIG. 3 is a view showing the relation between the transport optical depth <n> and a standardized source size (without absorption);

FIG. 4 is a view showing the relation between an optical loss (1−η) and the standardized source size (without absorption);

FIG. 5A is a view showing distribution (without absorption) of g·<n> which satisfies the condition of optical output η >0.8, and source size >80% of maximum source size;

FIG. 5B is a view showing experimental results about source size/maximum source size, and the optical loss with respect to g·<n>;

FIG. 6 is a view showing the relation between the optical loss and the standardized source size (albedo is 0.9999);

FIG. 7 is a view showing the relation between the optical loss and the standardized source size (albedo is 0.999);

FIG. 8 is a view showing the relation between an albedo γ and a preferable asymmetry factor g;

FIG. 9 is a view showing the relation between the asymmetry factor g and a preferable transport optical depth <n> (albedo is 0.9997);

FIG. 10 is a view showing the relation between the asymmetry factor g and the preferable transport optical depth <n> (albedo is 0.99997);

FIG. 11 is a view showing the albedo γ and a preferable g·<n>;

FIG. 12 is a view showing the albedo γ and a more preferable g·<n>;

FIG. 13 is a cross sectional view showing the structure of an optical module embodying a light source apparatus in a fourth embodiment of the present invention;

FIG. 14 is a cross sectional view showing the structure of an optical module as an example of a light source apparatus in a fifth embodiment of the present invention;

FIG. 15 is a view showing optical field intensity distribution of the optical module;

FIG. 16 is a cross sectional view showing the structure of an optical module as an example of a light source apparatus in a sixth embodiment of the present invention;

FIG. 17 is a view showing fluctuation of the thickness of the optical scattering region in the optical module embodying the light source apparatus in the sixth embodiment;

FIG. 18 is a cross sectional view showing the structure of an optical module as an example of a light source apparatus in another form in the sixth embodiment of the present invention;

FIG. 19 is a schematic view showing the structure of an optical wireless communication system as an example of an optical communication apparatus in a seventh embodiment of the present invention;

FIG. 20 is a cross sectional view showing the structure of a conventional light source apparatus;

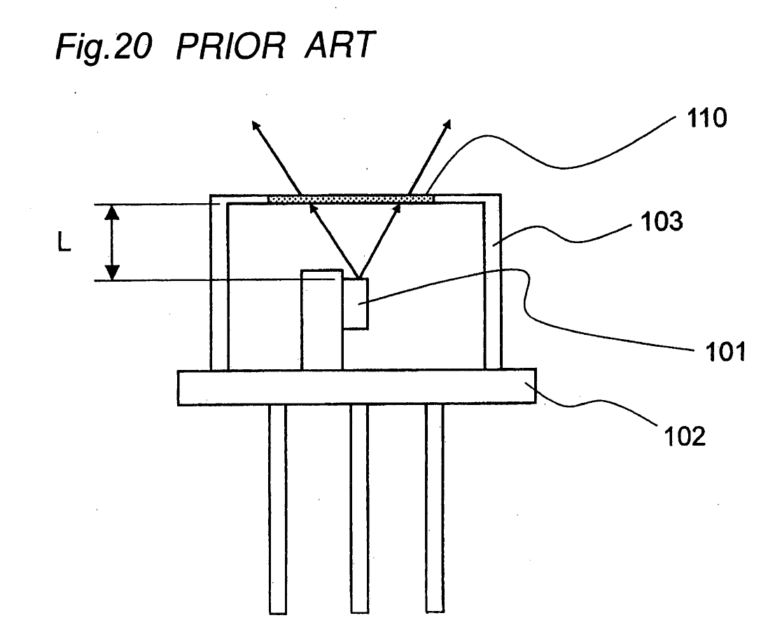

FIG. 21 is a cross sectional view showing the structure of another conventional light source apparatus;

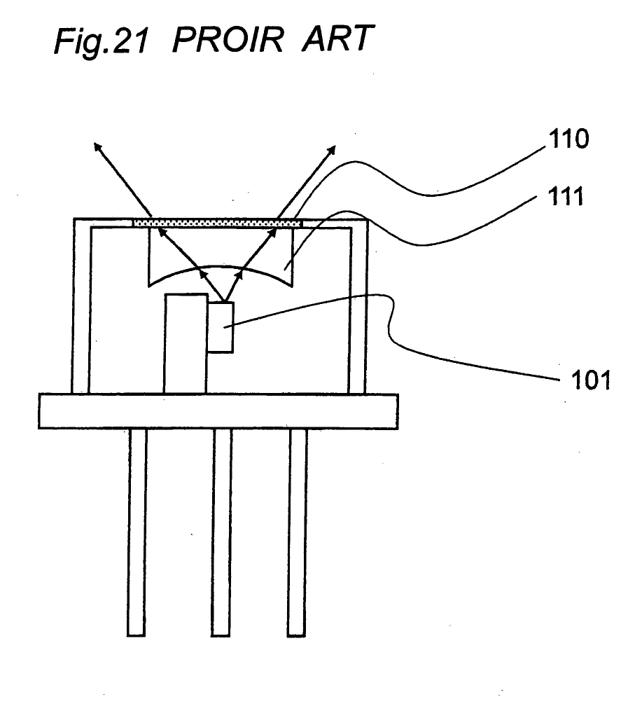

FIG. 22 is a view showing changes of the asymmetry factor g with respect to an index of refraction and a particle size;

FIG. 23 is a view showing changes of scattering sectional area Qsca with respect to the index of refraction and the particle size;

FIG. 24 is a view showing changes of 3Qsca·(1-g)g/2 d with respect to the index of refraction and the particle size;

FIG. 25 is a view showing changes of 3Qsca (1-g)g/2 d with respect to the index of refraction and the particle size;

FIG. 26 is a schematic view showing a lighting system using a light source apparatus in an eighth embodiment of the present invention; and

FIG. 27 is a schematic view showing a lighting system having an optical communication function using a light source apparatus in a ninth embodiment of the present invention.

### DETAILED DESCRIPTION OF THE PREFERRED EMBODIMENTS

Before description of the preferred embodiments proceeds, each term for use in the present specification will be described first. “Light scattering particles” exist in a resin having an even index of refraction, and their size are set at not more than several dozen times as large as the wavelength. Light scattering seen in such a case is called Mie scattering. In the Mie scattering, a scattering sectional area and angle distribution due to scattering are obtained by calculation. In the present invention, there are used three parameters: “asymmetry factor g” that is a mean value of cosine cos θ of scattering angles θ produced through scattering by light scattering particles; “transport optical depth <n>” obtained by dividing substantial optical path length L by transport mean free path μ′; and “albedo γ” representing light absorption. The “asymmetry factor g” is defined by the following equation.
g=<cos θ> (equation 1)

The transport mean free path μ′ is herein defined from a mean free path u and the asymmetry factor g by the following formula.
μ′=μ/(1−g)
When light travels for a distance X within a light scattering region where a mean free path is μ, probability that the light is free from scattering is generally represented by exp(−X/μ), while when the asymmetry factor g is 1 in the Mie scattering, scattering does not occur. Therefore, the particle density is defined by the transport mean free path μ′ depending on the value of the asymmetry factor g.

Concrete method for getting the asymmetry factor g, the transport mean free path μ′, and the albedo γ is stated, for example, in the document titled “Applied Optics vol. 40 (2001) pp1514-1524”. More particularly, the asymmetry factor g, the mean free path μ′, and the albedo γ can be calculated based on data including the index of refraction, the particle size and the specific gravity of a base material and light scattering particles.

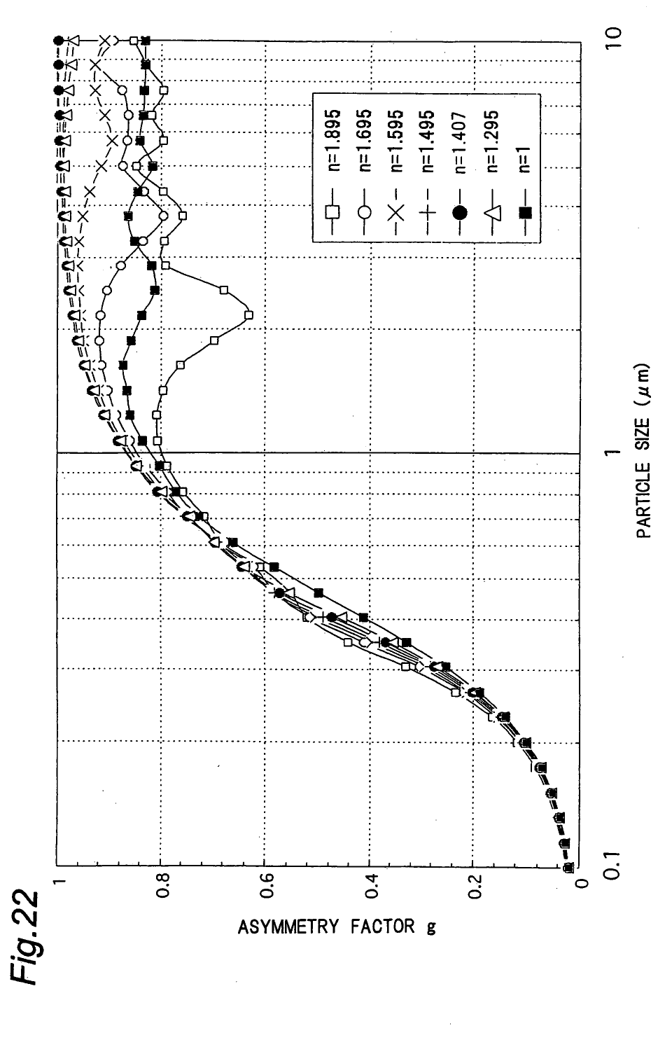

FIG. 22 shows a calculation example of the asymmetry factor g when light scattering particles whose index of refraction with respect to light of a wavelength of 890 nm is 1.0 to 1.895 are mixed in a silicon whose index of refraction with respect to the same light is 1.405, in which the asymmetry factor g changes depending on the index of refraction and the particle size. In FIG. 22, each index of refraction n is expressed as follows:
Square (□) denotes n=1.895;
Circle (∘) denotes n=1.695;
Cross shape (x) denotes n=1.595;
Plus shape (+) denotes n=1.495;
Black circle (●) denotes n=1.407;
Triangle (Δ) denotes n=1.295; and
Black square (▪) denotes n=1.

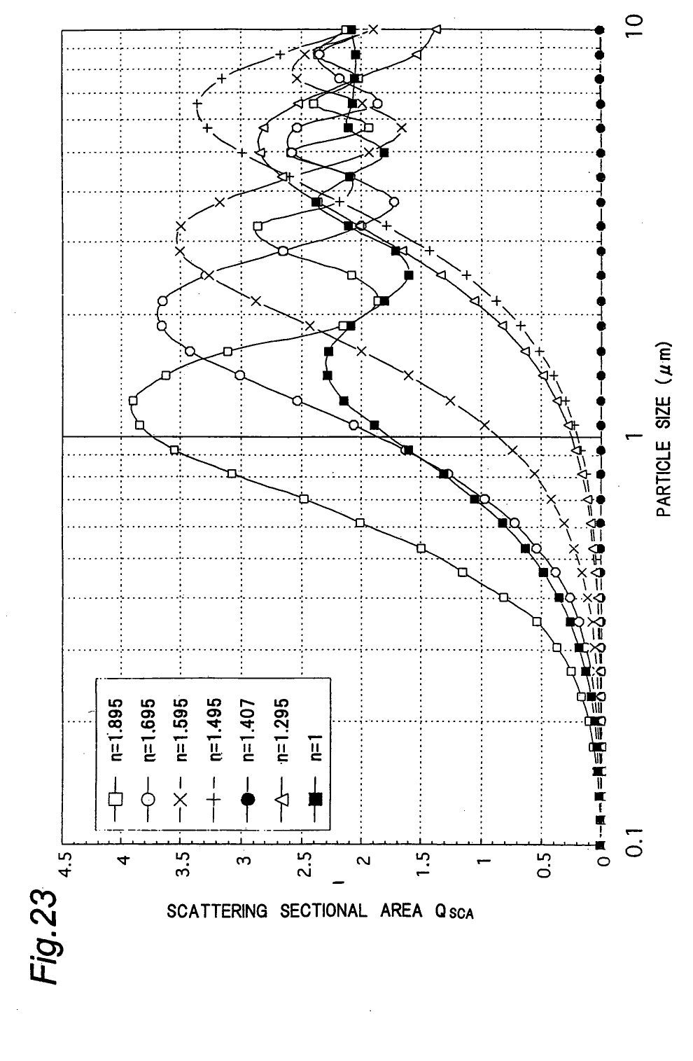

Similarly, FIG. 23 shows changes of scattering sectional area Qsca with respect to the index of refraction and the particle size. In FIG. 23, each index of refraction n is identical to that in FIG. 22. Based on the scattering sectional area Qsca, a voluminal mixing ratio of the light scattering particles volr and a particle size d, the mean free path μ is defined by the following equation:

$$μ = \frac{2 d}{3 Q sca} ( \frac{1}{volr} ) \qquad ( Equation 8 )$$

The “albedo γ”, a parameter of light absorption, is defined from a mean free path μ of scattering and a mean free path μa of absorption by the following equation.

$$γ = \frac{1 / μ}{1 / μ + 1 / {μ}_{a}} \qquad ( Equation 2 )$$

Though not illustrated herein, providing a complex index of refraction of light scattering particles allows accurate calculation of the mean free path μa. By this, the albedo γ is obtained.

Physical image of light scattering is found, for example, in the document titled “Pure Applied Optics, vol. 3 (1994), pp.897-905”. In this document, it is indicated that with <n> ≦1, i.e., L≦μ′, the directional property of light may completely disappear. Therefore, disappearance of coherency requires <n> >1.

It is impossible to obtain an albedo γ unless an accurate complex index of refraction of light scattering particles is obtained. Moreover, the light scattering particles available on industrial purposes are not necessarily consistent in particle size, and therefore how to obtain the values of g, μ and γ in such a case are rather complicated.

In the present invention, the asymmetry factor g is prescribed by using the following method.

That is, in the case of the light scattering particles in which particles with particle sizes from r to r+dr are contained in the proportion of p(r)dr to total volumes, the asymmetry factor g is obtained in the following equation 3 based on weighted average of a asymmetry factor gᵢ(r) of particles with particle size r:

$$g = {\int }_{0}^{∞} p ( r ) {g}_{i} ( r ) ⅆ r \qquad ( equation 3 )$$

It is to be noted that in the equation 3, the following equation applies:

$${\int }_{0}^{∞} p ( r ) ⅆ r = 1 ,$$

wherein p(r) represents a distribution function of the particle size.

It is to be noted that in the case of light scattering particles consisting of mixture of a plurality of different scattering particles (e.g., of n types), structuring the light scattering region by the method of the present invention with use of a mean value of their respective g values makes it possible to achieve the effects peculiar to the present invention including increase in source size and decrease in optical loss. In this case, based on the same logical consideration, the asymmetry factor g is expressed by the following formulas:

$$\begin{matrix}g = {\sum }_{j = 1}^{n} {f}_{i} {\int }_{0}^{∞} {p}_{j} ( r ) {g}_{ji} ( r ) ⅆ r ; and \\ {\sum }_{j = 1}^{n} {f}_{i} = 1 ,\end{matrix}$$

wherein gⱼᵢ(r) represents a asymmetry factor of particles which is of jth type and has a size r, and fⱼ represents a ratio between the numbers of respective particles.

In obtaining the mean free path μ, it has been confirmed by an experiment that a means value of respective particle sizes <r> can be used without causing any problem. There are cases where index of refraction data in a desired wavelength may not be obtained. Eventually in most cases, the index of refraction measured with use of a sodium lamp (with a wavelength of 589 nm) is typically presented, and it has been confirmed by an experiment that even if the index of refraction values measured with use of the light of a wavelength of 589 nm from the sodium lamp is applied in situ as the index of refraction data in the wavelengths from visible light to near-infrared light regions used in optical communication and the like, no substantial difference is found in determining the parameters of scattering, i.e., the asymmetry factor g and the mean free path μ.

Detailed description is hereinbelow give of the light source apparatus of the present invention and the optical communication apparatus using the same in conjunction with the preferred embodiments with reference to the accompanying drawings.

### First Embodiment

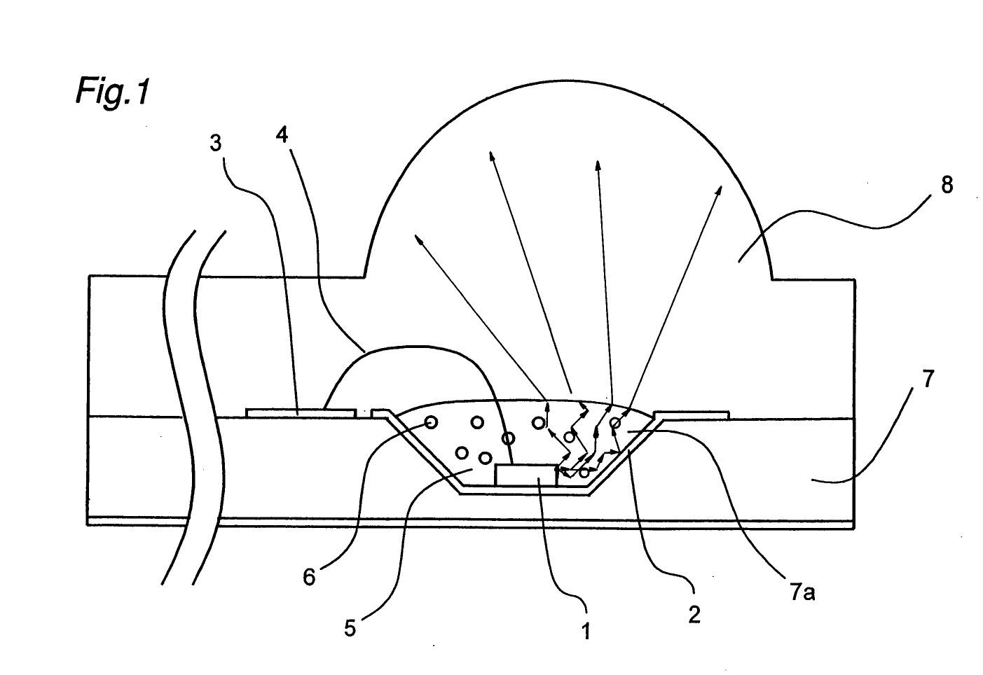

FIG. 1 is a cross sectional view showing the structure of an optical module as an example of a light source apparatus in a first embodiment of the present invention. Hereinbelow, description is given of the optical module in the first embodiment.

As shown in FIG. 1, the optical module in the first embodiment is structured such that an inverted cone trapezoid-shaped countersunk hole 7a for disposing a semiconductor laser chip 1 exemplifying the semiconductor laser device is provided on a glass epoxy board 7. On the bottom surface and the inclined surface of the countersunk hole 7a, there is formed a metal reflecting section 2 by gold coating. The metal reflecting section 2 functions as a lower electrode and a light reflecting section of the semiconductor laser chip 1. On the middle portion of the bottom section of the countersunk hole 7a, the semiconductor laser chip 1 is mounted by die-bonding with a conductive paste material. An upper electrode formed on the top surface of the semiconductor laser chip 1 is electrically connected to an electrode pattern 3 formed on the glass epoxy board 7 through a gold wire 4. Further, there is formed a light scattering region 5 made of resin inside the countersunk hole 7a.

Description is now given of the light scattering region 5, which is a major component part of the present invention. The resin forming the light scattering region 5 is formed from light scattering particles 6 which are almost evenly mixed into a silicon gel. The manufacturing method is composed of the steps of: mixing a specified amount of light scattering particles into a thermosetting liquid silicon; stirring the liquid with a stirrer; then when the liquid is fully stirred and the light scattering particles are almost evenly stirred, injecting the liquid into the countersunk hole 7a to a not overflowing extent; thermosetting the liquid; and then finally forming an epoxy lens 8 by transfer molding.

The silicon gel used in the first embodiment has an index of refraction of 1.405, and organic styrene particles (mean particle size: 1 μm, index of refraction: 1.595) are used as the light scattering particles 6. The mean particle size of the styrene particles is 1 μm, while respective particle sizes are distributed from a minimum 0.4 μm to a maximum 1.8 μm. Due to the manufacturing characteristics of the particles, the particle distribution does not show a symmetrical distribution around most frequent values, but tends to increase in distribution toward smaller particle sizes. In accordance with the equation 3, the weighted average asymmetry factor g was 0.75.

Description is now given of the albedo γ. In the case where particles do not absorb light (in the case where 1/μₐ=0 in the equation 2 is considered to be satisfied), the value of the albedo γ is 1. In the case where particles absorb light, the albedo γ presents a value smaller than 1, though it is not easy to accurately obtain the value of the albedo γ in an experiment. It has been proved from the characteristics of organic styrene particles that the value of the albedo γ in the first embodiment can almost be assumed to be 1.

Next, the path length for determining the transport optical depth <n> is determined. The length (in direction parallel to the plane of the board 7 in FIG. 1) of the semiconductor laser chip 1 is 0.5 mm, the shape of the countersunk hole 7a is in an inverted cone trapezoid shape with the bottom surface being a circle with a radius of 0.35 mm, an angle of the inclined surface being 45 degrees, and a depth being 0.3 mm. Assuming that the light scattering particles 6 do not exist in the countersunk hole 7a, the light radiated horizontally from the end surface of the semiconductor laser chip 1 is reflected by the inclined surface of the metal reflecting section 2, where the light changes its direction to right overhead, and then the light is radiated out of the countersunk hole 7a. The distance of this journey is 0.4 mm. This distance is defined as a path length L. In designing optical systems, there are cases where it is impossible to define such a path length L, the detail of which will be given in the later-described fourth embodiment.

The styrene particles were mixed into the silicon gel at a weight ratio of 11% to 55%. Thus-obtained light scattering agent (silicon gel mixed with light scattering particles) had a mean free path μ of 2.5 μm to 125 μm. It is to be noted that the asymmetry factor g is 0.75, and therefore the transport optical depth <n> is 0.8 to 40.

Description is now given of actual light scattering in the optical module. Light emitted from the semiconductor laser chip 1 is scattered a plurality of times by the light scattering particles 6 existing in the light scattering region 5, reflected by the inclined surface of the metal reflecting section 2 in the countersunk hole 7a, and finally radiated from the light scattering region 5 to the epoxy lens 8. During this process, in the countersunk hole 7a, light undergoes a number of scattering operations in concurrence with a number of metal reflecting operations, and then part of the light is absorbed by the metal and other part of the light is extracted from the countersunk hole 7a to the epoxy lens 8. Therefore, a ratio of light effectively extracted from the light scattering region 5, i.e., optical output, is 1 or less. The object of the present invention is to maximize the source size while maintaining the optical output constant or more preferably maintaining the optical output to the level of η>0.8.

In the first embodiment, immediately before transfer molding of the epoxy lens 8, an intensity distribution of light emitted from the light scattering region 5 was observed. As a result, it was confirmed that as the transport optical depth <n> increased (as a weight ratio of the light scattering particles 6 in the light scattering region 5 increased), the source size increased, and when the transport optical depth reached <n>=7, the source size increased to an almost maximum source size 2 L (L represents a path length when light scattering particles do not exist). An obtained optical output η was as sufficiently high as 0.99. If the transport optical depth <n> further increased, the source size was reduced, and the optical output η was degraded. The source size which is increased up to approx. 2 L=0.8 mm in the interface between the light scattering region 5 and the epoxy lens 8 is further almost doubled by a lens gain of the epoxy lens 8. By these increase, the source size which is originally on the order of several μm is increased to mm order. It is naturally understood that the radiation intensity can be set at a desired half angle by adjusting the shape of the epoxy lens 8. According to the first embodiment, optimizing the asymmetry factor g and the transport optical depth <n> in the light scattering region allows both maximization of the source size and high optical output η.

The semiconductor laser chip 1 used in the first embodiment has a directional half-angle of ±5 degrees in horizontal direction and a directional half-angle of ±10 degrees in vertical direction of an active layer, which are small as directional half angles of laser devices. Therefore, by the method described in the Background of Invention, the source size increases about 0.3 times as large as the path length at most. However, in the first embodiment, the source size increases twice the path length, confirming the effect of increasing the source size in a smaller region. Even when the directional half angle of the semiconductor laser in use were changed, it was confirmed that the source size obtained in the first embodiment showed almost no change. More particularly, the effect of increasing the source size by the light scattering particles in the first embodiment is larger than the effect of increasing the directional half angle of the laser. Therefore, in the case of using a semiconductor laser having a directional half angle in the range of ±5 to ±30 degrees, generally it becomes possible to obtain almost the same source size. More particularly, it becomes possible to consistently obtain an almost constant source size without depending on either the directional half angle of the semiconductor laser in use or dispersion of the directional half angle. Moreover, it is apparent that even if the directional half angle changes, the optimum range of the asymmetry factor g and the transport optical depth <n> for increasing the source size with a shortest path length remains unchanged.

### Second Embodiment

Description is now given of the optical module as an example of the light source apparatus in a second embodiment of the present invention. The optical module in the second embodiment shares the same structure with the first embodiment except the light scattering region, and therefore FIG. 1 is also used as a reference. In the optical module in the second embodiment, an optimum asymmetry factor g for increasing the source size was obtained by an experiment based on the relation between the asymmetry factor g of the light scattering particles 6 in the light scattering region 5 and the transport optical depth <n> in the light scattering region.

In the structure of the optical module in the aforementioned first embodiment, it was already proved that the transport optical depth <n> of styrene particles having an asymmetry factor g of 0.75 can be optimized, and therefore it is herein discussed with much circumstance if further increase in source size is possible by using other asymmetry factor g. The semiconductor laser chip and the countersunk hole structure for use in this embodiment are identical to those in the first embodiment. The inventor of the present invention conducted an experiment by using, as light scattering particles, acrylic particles, TiO₂ particulates and SiO₂ particulates other than styrene particles. Changing the particle size of the above-stated particles made it possible to obtain five types of light scattering particles: TiO₂ particles of g=0.35, 0.58; styrene particles (same as the first embodiment) of g=0.75; acrylic particles of g=0.90; and SiO₂ particles of g=0.98. It is to be noted that each particle do not absorb light, and the value of albedo is not less than 0.9999, so that it can be regarded as 0.99999 or a value extremely close to 1.

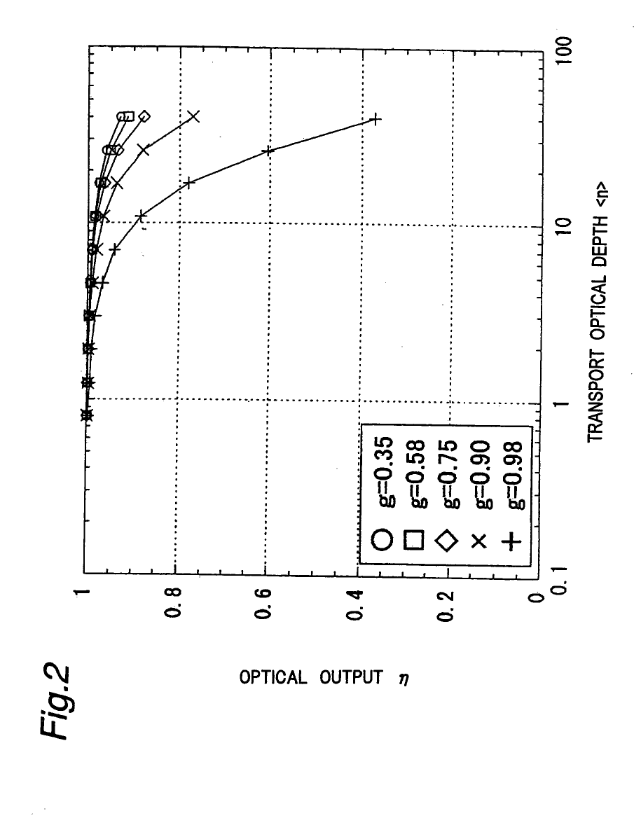

When the transport optical depth <n> in the light scattering region with use of thus-obtained light scattering particles was changed from 0.8 to 40, a result as shown in FIG. 2 was obtained. In FIG. 2, circle (◯) and square (□) respectively denote the results of TiO₂ particles of g=0.35 and g=0.58, rhombus (⋄) denotes the result of styrene particles of g=0.75, cross shape (x) denotes the result of acrylic particles of g=0.90, and plus shape (+) denotes the result of SiO₂ particles of g=0.98. Consequently, although the result that increase in transport optical depth made absorption of light by the metal more pronounced was the same as that obtained in the first embodiment, it was newly found out that larger asymmetry factor g increased the absorption of light by the metal.

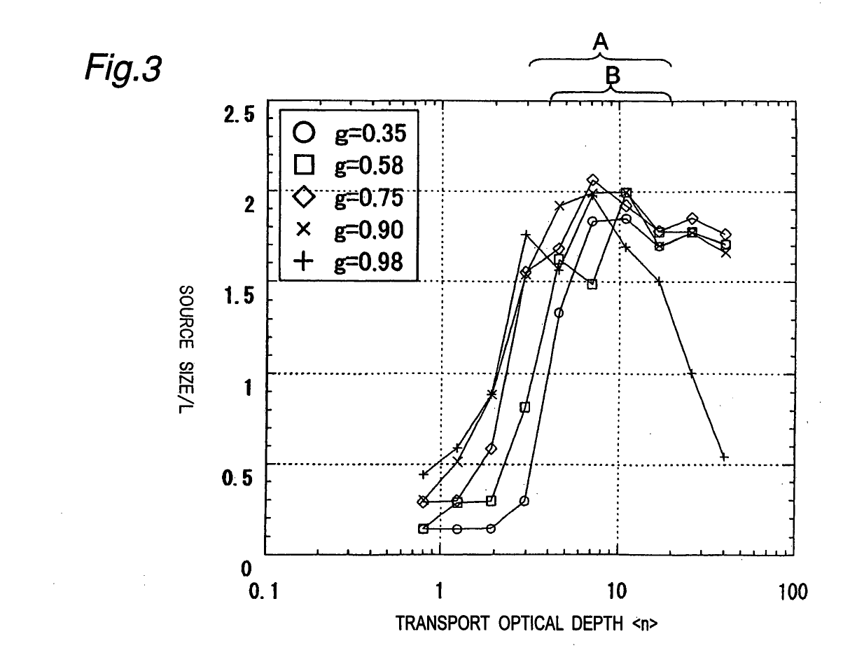

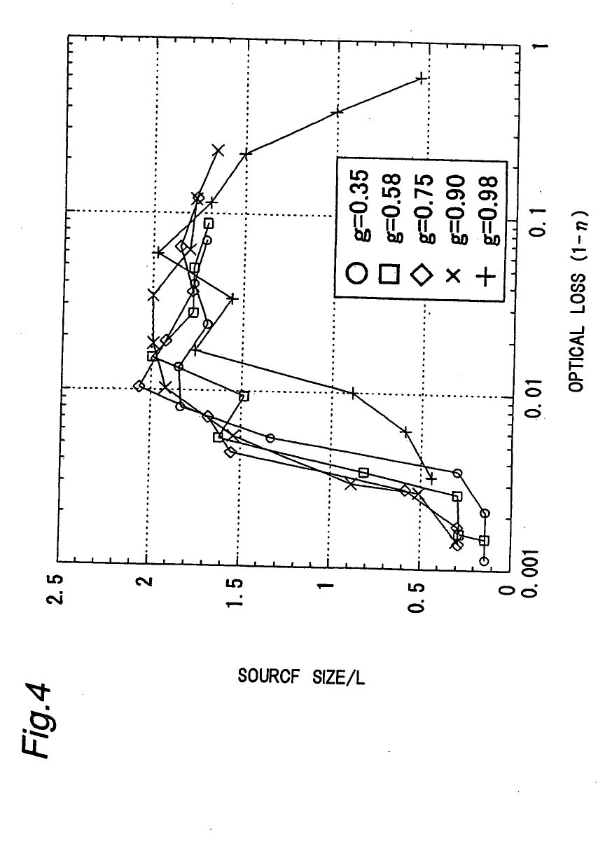

Further, as a result of examining the relation between the transport optical depth <n> and the source size/path length L, it was confirmed that as shown in FIG. 3, the optimum transport optical depth <n> for the largest source size was different by the asymmetry factor g. In FIG. 3, a value obtained by dividing the source size by the path length L is shown as a vertical axis. Hereinbelow, a value of the source size/path length L is referred to as “standardized source size”. Moreover, FIG. 4 shows a relation between optical loss (1−η) and the standardized source size. In FIGS. 3 and 4, respective circle (◯), square (□), rhombus (⋄), cross shape (x) and plus shape (+) show the same particles as those in FIG. 2. According to FIGS. 3 and 4, it was found out that in the case where there is no absorption by light scattering particles, “optical output η >0.8 and source size >80% of maximum source size” i may be achieved by setting the asymmetry factor g at an arbitrary value and by setting the transport optical depth <n> at a certain range corresponding to the value of g.

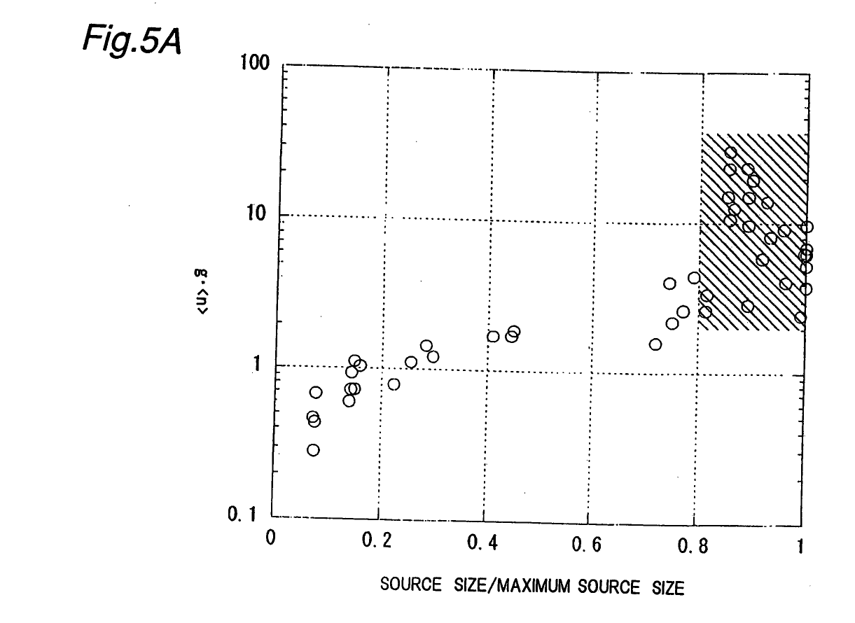

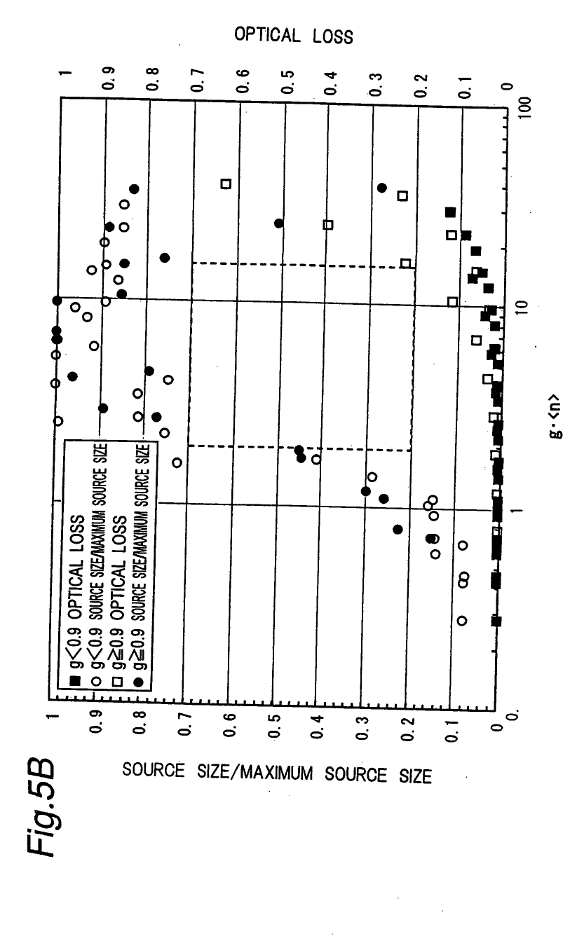

Moreover, by examining the range of <n> and g which satisfy the condition of optical output η >0.8, the result shown in FIG. 5A was obtained. In FIG. 5A, a horizontal axis shows a ratio of a source size to a maximum source size obtained with each asymmetry factor g, while a vertical axis shows a product g·<n> of the asymmetry factor g and the transport optical depth <n> at that time. As shown in FIG. 5A, the source size remains in a shaded region where the source size is 80% or more of the maximum source size when the following condition is satisfied:
2≦g·<n>≦40 (Equation 4)
Conversely, when the equation 4 is satisfied the source size of not less than 70% of the maximum source size is obtained at minimum, which is considerably larger than the source size shown in the following condition.
g·<n><2
In other words, the following formula is a necessary and sufficient condition for increasing the source size.
g·<n>≦2
While, with the following condition satisfied, the optical output η is degraded and therefore both the conditions: η>0.8; and source size >80% of maximum source size, fail to be fulfilled.
g·<n>≧40

Since a required size of the light source is changed in response to the light radiation intensity required by the system, the source size does not necessarily need to be 80% or more of the maximum source size. In the system which requires low radiation intensity, a large source size may be over spec. As a range which shows sufficient effects, the source size >1.4 L, which is almost 1.5 times as large as the maximum source size (0.9 L) stated in the description in Background of the Invention, is selected for example. Since the maximum source size is almost 2 L, the source size >1.4 L is achieved when the source size is 70% or more of the maximum source size. The optical output is higher the better in any system, and particularly in portable equipment which premise battery use, devices with lower power consumption are desired. In FIG. 5A, the range which satisfies only the condition of optical output η >0.8 is shown, while in FIG. 5B, all the previous experimental results are shown. This indicates that the condition of optical output η >0.8 with respect to an arbitrary asymmetry factor g may be satisfied with g·<n><15. With g·<n>≧2, the source size which is 70% of the maximum source size is consistently obtained.

FIG. 3 shows that for the effect of increasing the source size, the transport optical depth <n> is more preferably in the range (region A in FIG. 3) of the following:
3≦<n>≦20

Further, it was found out that setting the transport optical depth <n> in the range (region B in FIG. 3) shown in the following made it possible to gain the effect of increasing the source size regardless of how to select the asymmetry factor g:
4≦<n>≦20
Further, according to FIG. 4, a optical loss starts to increase with g>0.9, and therefore it is clear that the condition of g<0.9 is preferable for obtaining the light source involving a lower optical loss.

According to the second embodiment, the asymmetry factor g and the mean free path μ are obtained from a physical constant which is obtained from a parameter sheet of light scattering particles, by which the density of light scattering particles that maximizes the source size is stipulated. As a result, maintaining the optical output (η>0.8) and increasing the source size may be performed simultaneously. Further, in the case where the transport optical depth <n> in the optical system is limited to a certain range upon request for decreasing speckle and the like, it is possible to clearly determine which range of the asymmetry factor g the scattering particle for use should have.

As the asymmetry factor g is obtained from the particle size by calculation, consideration is now given of an optimum value of the particle size.

As shown in FIG. 22, when the particle size is 1 μm or less, the asymmetry factor g is less than 0.9 and so its dependency on index of refraction becomes smaller. When the particle size is 1 μm or more, larger difference in index of refraction from that of silicon decreases the asymmetry factor g, and there is observed vibration of the asymmetry factor g caused by the particle size.

FIG. 23 shows the scattering sectional area Qsca also in the state of vibrating. In the second embodiment, the following condition is presented:
2≦g·<n>≦40
Based on the equation 8, the following formula is provided:

$$g \cdot < n >= \frac{3 Qsca}{2 d} ( 1 - g ) g \cdot volr \cdot L$$

The above formula is derived by substituting μ of the equation 8 for μ in the following formulas.
<n>=L/μ′=L(1−g)/μ
g·<n>=L(1−g)/μ
Among the terms in the above formula, the term shown below is determined not by the structure of the light scattering region or the density of the light scattering particles, but only by the type of particles:

$$\frac{3 Qsca}{2 d} ( 1 - g ) g$$

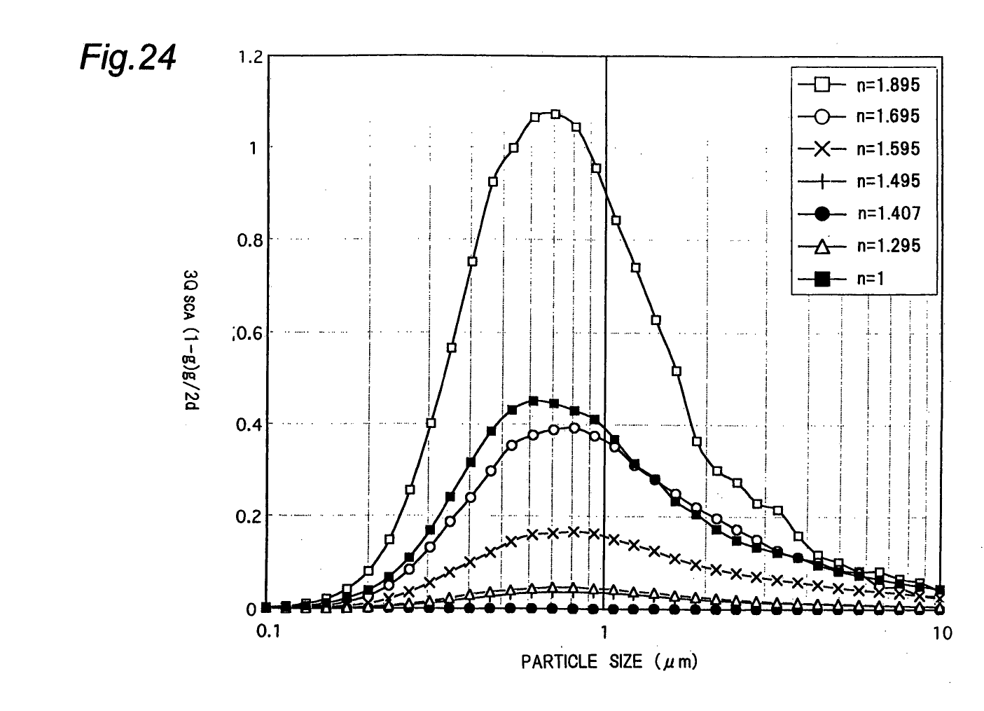

FIG. 24 shows changes of 3Qsca·(1−g)g/2 d with respect to the index of refraction and the particle size. In FIG. 24, a horizontal axis represents the particle size (μm) and a vertical axis represents values of 3Qsca·(1−g)g/2 d. The graph indicates that although peak values are different from each other by the index of refraction of respective particles, the particle size to be peaked is in the range of 0.6 to 0.9 μm. Our purpose is to gain large light source and low optical loss with small L. The purpose can be achieved by fulfilling the following condition:
2≦g·<n>≦40
Therefore, it is apparently more preferable that the following value becomes larger.

$$\frac{3 Qsca}{2 d} ( 1 - g ) g$$

The materials of light scattering particles should preferably be rich in the particles with a particle size of 0.6 to 0.9 μm regardless of the type of material of the light scattering particles. Since the particle size changes in response to the light wavelength, an optimum parameter may be expressed as particle size/wavelength=0.67 to 1.0.

Consideration is now given of difference in index of refraction between the base material and the light scattering particles. A ratio of volumes of mixture volr reaches a maximum value 0.68 in the state of closest packing. In the second embodiment, the path length L is 0.4 mm(=400 μm), so that for satisfying the following condition:
g·<n>≧2,
the following condition is required:

$$\frac{3 Qsca}{2 d} ( 1 - g ) g \geq 0.00073 \qquad ( Equation 9 )$$

This condition can be changed by change in the path length L. Actually, when the path length is elongated, the range equired of 3Qsca (1−g)g/2 d becomes more broad than the equation 9. It is preferable to design the refractive index using the path length L of 0.4 mm, because elongating the path length is not preferable in view of the object of the present invention. While, it is obvious that the equation 9 capable of enlarging the source size with short path length exerts its effect, even in the case where the path length is long.

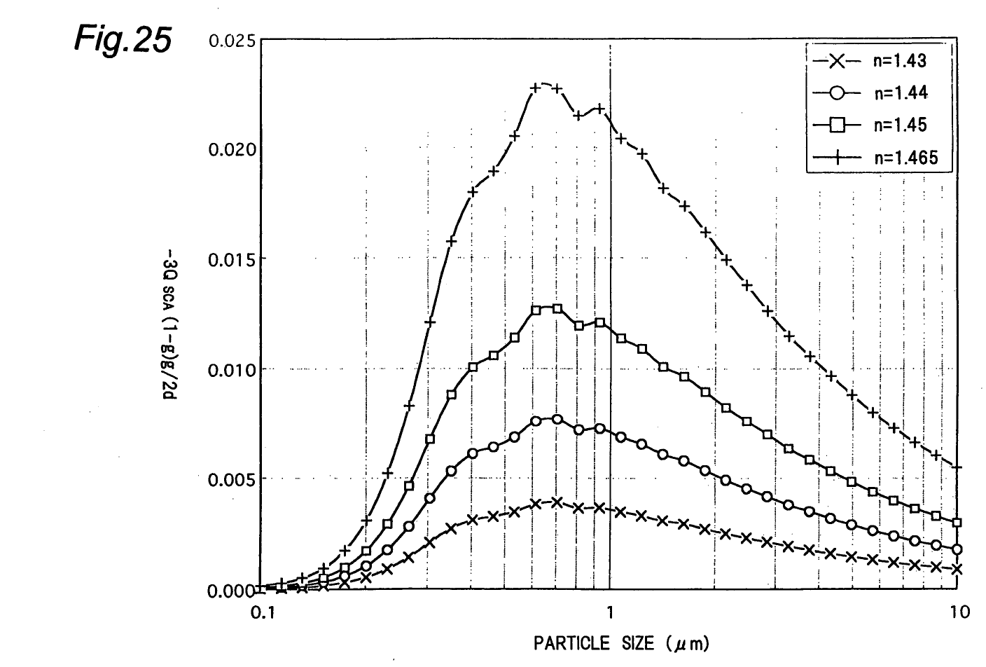

FIG. 25 shows changes of the following value with respect to the index of refraction and the particle size when the index of refraction of light scattering particles is close to the index of refraction of the base material:

$$\frac{3 Qsca}{2 d} ( 1 - g ) g$$

In FIG. 25, each index of refraction n is expressed as follows:
Cross shape (x) denotes n=1.43;
Circle (◯) denotes n=1.44;
Square (□) denotes n=1.45; and
Plus shape (+) denotes n=1.465.

From FIG. 25, it is understood that the value of the vertical axis exceeds 0.0073 when n=1.44 or higher. Consequently, it is appropriate that the index of refraction of the base material is 1.405, particle size/wavelength=0.67 to 1.0, and Δn>0.035 wherein Δn=|index of refraction of base material−index of refraction of light scattering particles|. In other words, the condition of g·<n>≧2 is achieved only when such particles are used. Although an optimum value of Δn is 0.035 or higher in the second embodiment, it is easily understood that strictly speaking, the condition of Δn are changed by using materials whose base materials have different index of refractions because the asymmetry factor g is determined based on the index of refraction against the base material. In this embodiment, Δn is 0.025 or higher in terms of a ratio to the refractive index of the base material.

In actuality, closest packing, which sets a voluminal ratio of mixing at 0.68, is not desirable because it eliminates irregularity in arrays of light scattering particles. As for evaluation of this random scattering, we have obtained a certain measure of knowledge by evaluating the speckle of laser light radiated to external space. Though the detail is not described here, it is confirmed that the speckle starts to increase when the voluminal ratio of mixture is over 25%. Consequently, the preferable voluminal ratio of mixture is 0.25 or lower, and therefore, the following value is preferable:

$$\frac{3 Qsca}{2 d} ( 1 - g ) g \geq 0.02$$

Similarly, it is understood from FIG. 25 that the condition of the difference in index of refraction is Δn>0.06. In terms of a ratio to the refractive index of the base material, the value of the difference is equivalent to not less than 0.043 times as large as the refractive index of the base material.

An upper limit of Δn value cannot be determined by the condition of g·<n>≦40. By adjusting the voluminal ratio of mixture to be smaller, the value can be confined to this range.

### Third Embodiment

Description is now given of an optical module as an example of the light source apparatus in a third embodiment of the present invention. The optical module in the third embodiment shares the same structure with the first embodiment except the light scattering region, and therefore FIG. 1 is also used as a reference. In the optical module in the third embodiment, an optimum asymmetry factor g in the case where consideration is given to an albedo γ which represents the degree of absorption in the light scattering region was obtained by an experiment.

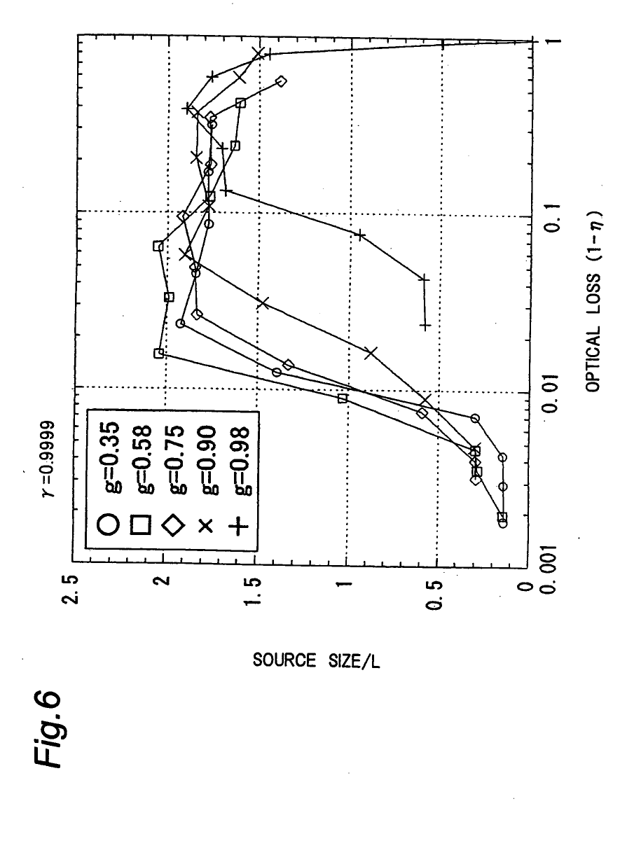

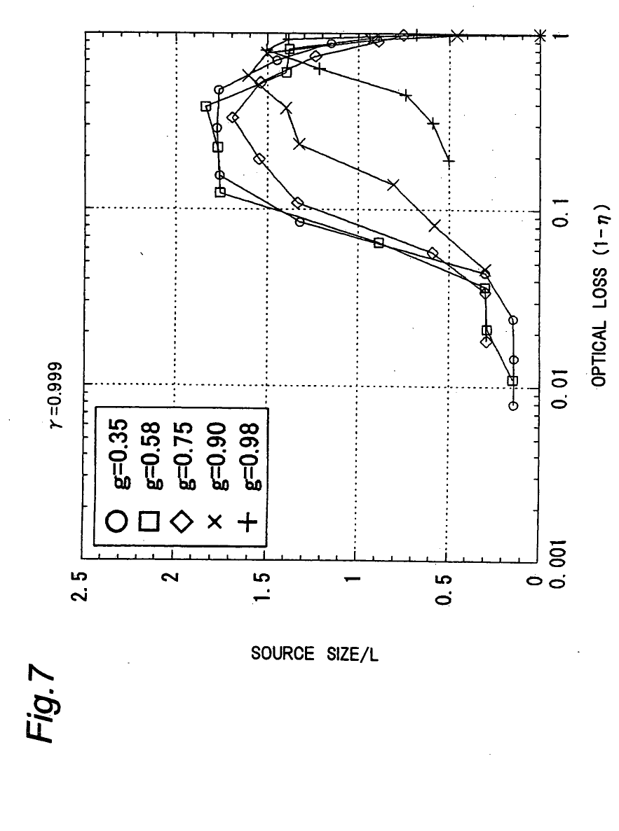

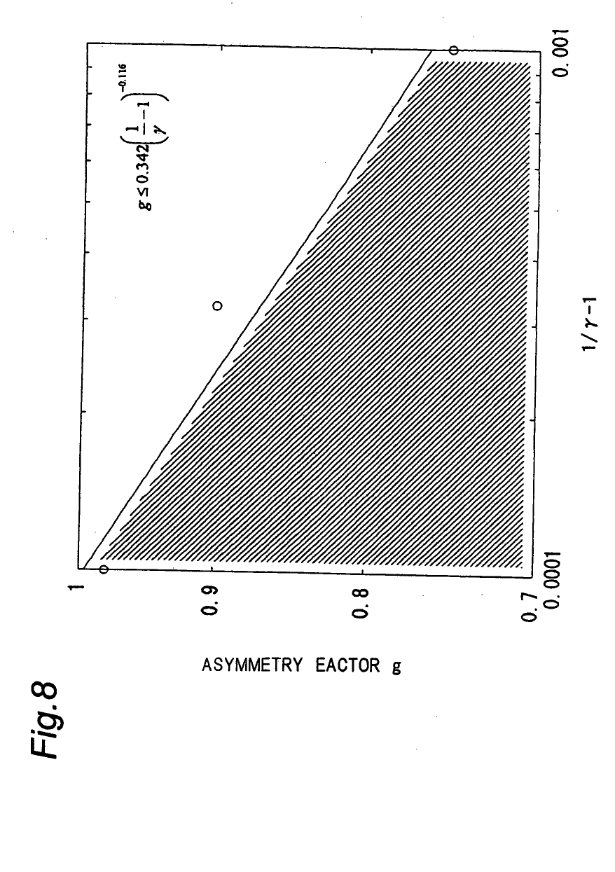

Description will be given of the result of an experiment in which surface treatment is applied to the light scattering particles 6 in the light scattering region 5 and a certain albedo is given. In this experiment, the particle size of the light scattering particles 6 is unchanged and the value of the asymmetry factor g is the same. In this experiment, the albedo γ is changed in the range of 0.9990 to 0.99997. Two examples of the experiment with the albedo γ=0.9999 and 0.999 are shown in FIG. 6 and FIG. 7, in which change of the optical loss and source size is shown with the transport optical depth <n> being changed. Herein, circle (◯) and square (□) respectively denote the results of TiO₂ particles of g=0.35 and g=0.58, rhombus (⋄) denotes the result of styrene particles of g=0.75, cross shape (x) denotes the result of acrylic particles of g=0.90, and plus shape (+) denotes the result of SiO₂ particles of g=0.98. The results of FIG. 6 and FIG. 7 confirm that with increased absorption, the light source does not become larger but shifts to the direction of a larger optical loss. It was indicated herein that as the value of albedo decreased (as absorption increased), the value of the required asymmetry factor g became smaller. It was found out that if the following condition was required in each value of albedo as with the second embodiment:
η >0.8 and source size >80% of maximum source size,
then the albedo γ and the asymmetry factor g needed the relation as shown in FIG. 8. More particularly, the albedo γ and the asymmetry factor g need to satisfy the following condition:

$$g \leq 0.342 {( \frac{1}{γ} - 1 )}^{- 0.116} \qquad ( equation 5 )$$

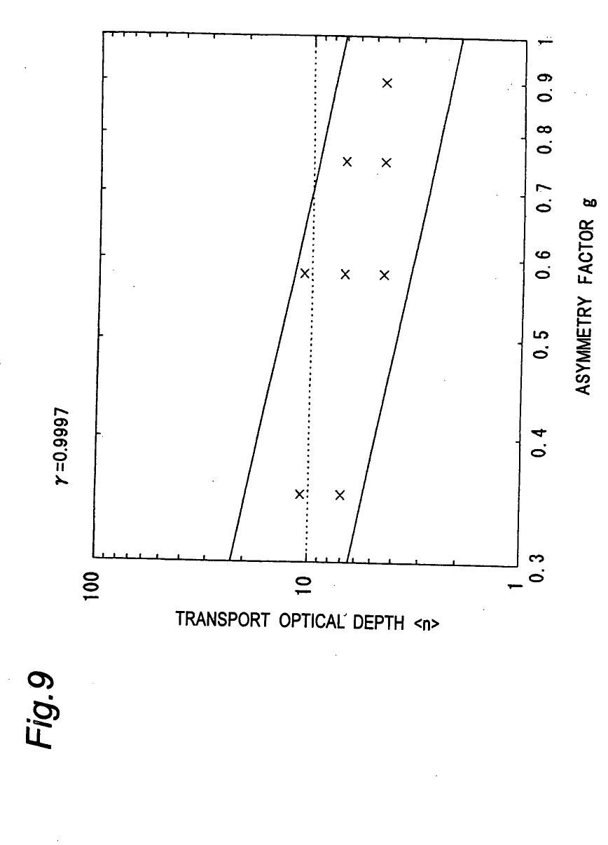

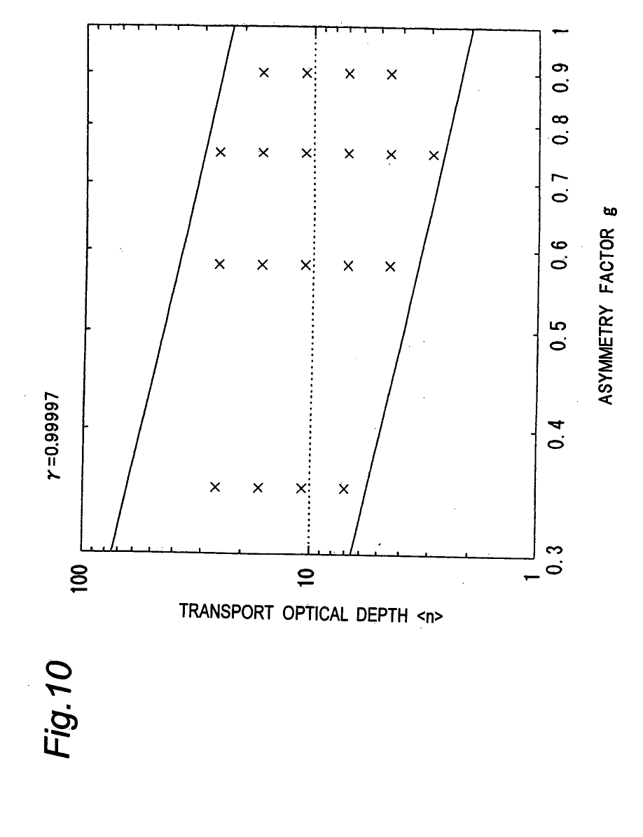

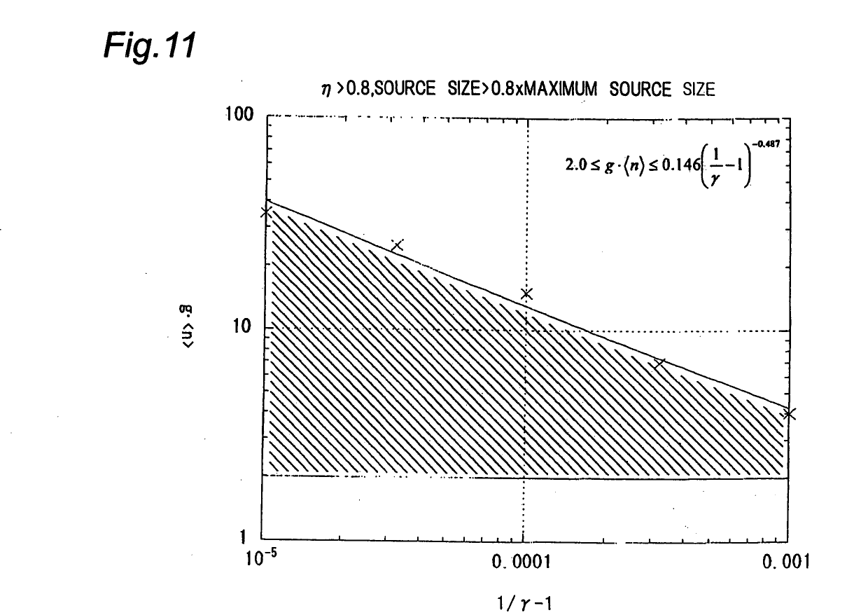

Similarly, as a result of performing the similar analysis over albedo γ=0.9997 and 0.99997 which are not shown in FIG. 6 and FIG. 7, FIG. 9 and FIG. 10 show the range of g and <n> which satisfies the following condition:
η>0.8 and source size >80% of maximum source size
   These results disclose the followings. FIG. 9 and FIG. 10 show the range of g and <n> which satisfies the above condition “η>0.8 and source size >80% of maximum source size” with the value of albedo γ being changed. Consequently, it is found out that a lower limit value of g·<n> is not changed by change in the level of absorption, whereas an upper limit value of g·<n> is decreased as the level of absorption increases. The relation between the upper limit value of g·<n> and the albedo γ is shown by cross shape (x) in FIG. 11. In FIG. 11, a vertical axis represents the value of g·<n>, while a horizontal axis represents (1/γ)−1.

By this, the following condition is obtained:

$$2 \leq g \cdot < n > \leq 0146 {( \frac{1}{γ} - 1 )}^{- 0.487} \qquad ( equation 6 )$$

Since the right-side terms in the above equations 5 and 6 become infinite at the limit value of 1 of the albedo γ, and therefore regions other than the region stated in the second embodiment should be contained. When the value of the albedo γ is 1 without light absorption, then g<1 and the equation 4 are applied.

Practically, the albedo γ is often impossible to be obtained from the parameter sheet of light scattering particles, and therefore it is expected that designing on the assumption that γ is almost equal to 1 provides a sufficient effect. More particularly, the equation 4 should be applied to all the light scattering particles, and in the case where specific values of the albedo γ are available, the equation 5 and equation 6 should be applied.

According to the third embodiment, the asymmetry factor g and the transport optical depth <n> for the light scattering particles which absorb light are optimized. For example, depending on laser wavelengths (of blue-violet laser and the like), there may be cases where available particles are limited to those which absorb light. In such cases, using the asymmetry factor g prescribed in the equation 5 makes it possible to maintain the condition of optical output η >0.8 while maximizing the source size.

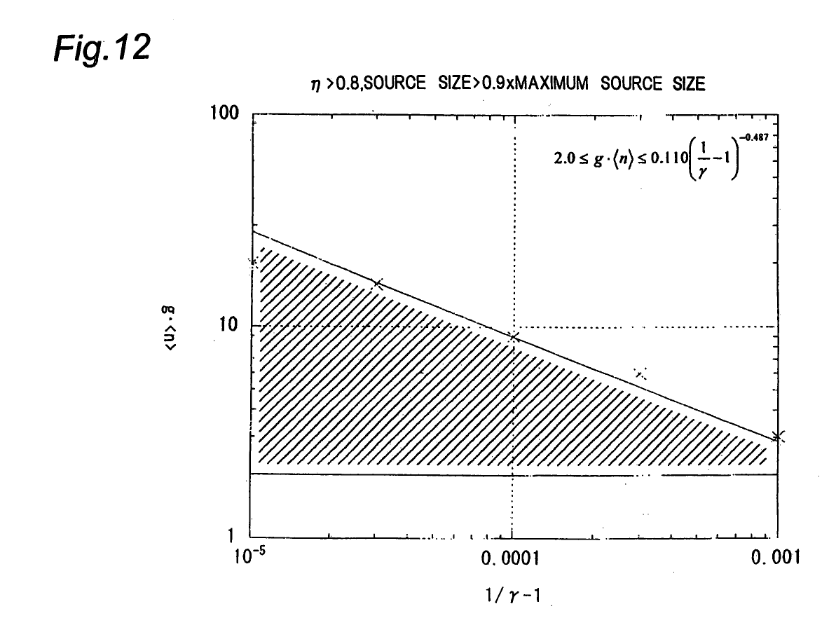

As a more preferable condition, the range which offers the source size that is up to 90% of the maximum source size is shown in FIG. 12. In FIG. 12, a vertical axis represents a product g·<n>, while a horizontal axis represents (1/γ)−1. From the FIG. 12, it is found out that a still smaller value of the product g·<n> of the transport optical depth <n> and the asymmetry factor g is required, and that inclination remains unchanged and dependency on the albedo γ is identical. As a result, the source size which is up to 90% of the maximum source size may be obtained if the product g·<n> satisfies the condition shown below:

$$2 \leq g \cdot < n > \leq 0.110 {( \frac{1}{γ} - 1 )}^{- 0.487} \qquad ( Equation 7 )$$

In the first embodiment, description was given of the example where styrene particles are used as light scattering particles, and in the second embodiment, description was given of the example where TiO₂, SiO₂ and acrylic particles are used as light scattering particles. Examples of the light scattering particles may include metal, semiconductors, glass and resin, among which the metal and semiconductors involve no small amount of absorption, which causes decrease in albedo and in optical output η. In the case of glass, the specific gravity is considerably different from that of a base material, which causes sedimentation, thereby offering poor controllability of the density of light scattering particles. At the present time, resin materials are most preferable as light scattering particles available on industrial purposes. As the base material, from the viewpoint of weather resistance and heat resistance, silicon is best suited. In consideration of difference in index of refraction, following materials are usable: polysulfone (index of refraction of about 1.63); polyethylene (index of refraction of about 1.54); polypropylene (index of refraction of about 1.48); polycarbonate (index of refraction of about 1.59); vinyl chloride; phenol resin; and epoxy resin (respective index of refractions are about 1.52 to 1.65). Particularly, acrylic particles (polymethyl methacrylate with index of refraction of about 1.50), styrene particles (polymethyl styrene with index of refraction of about 1.60), and polybutyl methacrylate (index of refraction of about 1.49) are preferred for use in the present invention as particles close to a perfect sphere can be obtained therefrom.

### Fourth Embodiment

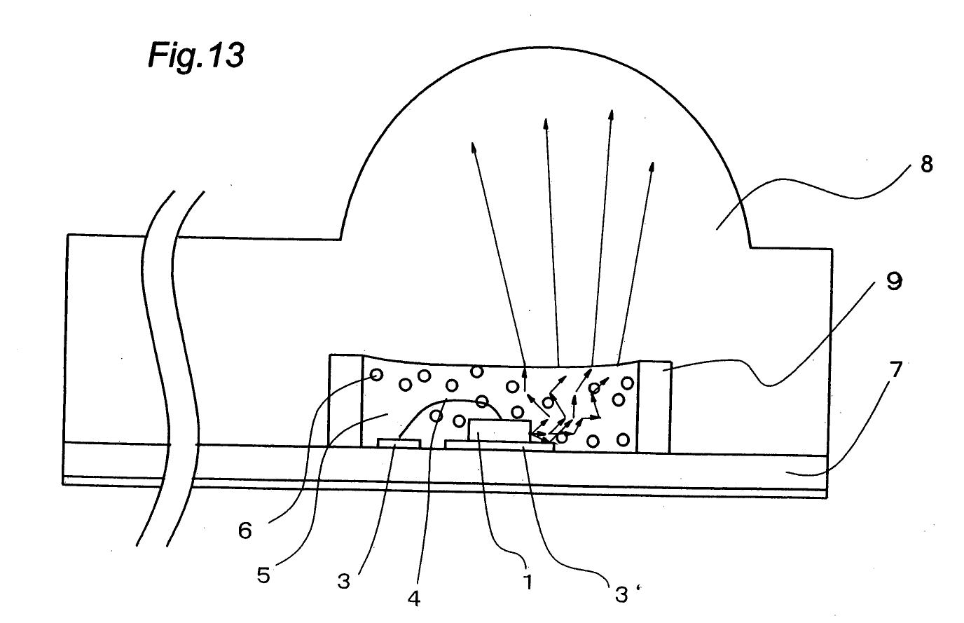

FIG. 13 is a cross sectional view showing the structure of an optical module as an example of a light source apparatus in a fourth embodiment of the present invention. Description is hereinbelow given of the optical module of the fourth embodiment. The optical module shown in FIG. 13 is different from the optical module in the first embodiment in the point that the path length L cannot be defined.

As shown in FIG. 13, a wire and bonding pads 3, 3′ are formed by gold coating on a glass epoxy board 7. On top thereof, a copper plate with a thickness of 0.5 mm is bonded with a resin bonding agent, and the copper plate is etched into a circular shape so as to form a cylinder 9 with a height of 0.5 mm and an internal diameter of 1.6 mm. The semiconductor laser chip 1 is die-bonded to the top of the pad 3′ in the cylinder 9, and a wire 4 is provided between the semiconductor laser chip 1 and the pad 3 as in the first embodiment. As for the light scattering region 5, the same base material and light scattering particles 6 as those in the first embodiment, which are silicon gel and styrene particles (g=0.75), are used. In this case, an optical axis of the light emitted from the end surface of the semiconductor laser chip 1 is in horizontal direction parallel to the top surface of the board 7 in FIG. 13, and therefore it is impossible to define the path length L by the method as shown in the embodiment 1. However, actual light is reflected by the metal while being scattered, and is eventually radiated out of the light scattering region 5 unless it is absorbed. The inventor of the present invention repeatedly conducted experiments and could obtain results which were approximately consistent with the previous experimental results by setting this path length L to be twice as long as the shortest distance, that is from a point of the light scattering region 5 to which light is incident and to a point of the region from which the light exits. In the case of this example, the shortest distance is from the end surface of the semiconductor laser chip 1 to the epoxy lens 8 up from the board 7. Further, though not illustrated, depending on optical systems, “path length L along the optical axis” stipulated in the first embodiment and “path length L twice as long as the shortest distance” may be defined simultaneously. In such a case, whichever smaller path length L should be selected.

In the fourth embodiment, a luminous point of the semiconductor laser chip 1 is at a position 0.1 mm high from the surface of the glass epoxy board 7, and the path length L by the above definition is L=(0.5-0.1)×2=0.6 mm. Herein, in order to achieve the condition of the transport optical depth <n>=5, the light scattering particles 6 are mixed in at a weight ratio of 8.3%.

Thus-obtained source size is approx. 1.6 mm with the lens increase effect included. At this point, the original source size of the semiconductor laser chip 1 could be increased 1000 times larger. In this fourth embodiment, the semiconductor laser chip 1 is mounted on the board without a countersunk hole. In the board processing step, the processing accuracy of the countersunk hole is typically ±0.1 mm deep, and this is one of the causes of dispersion in optical characteristics of the light source apparatus. This problem is avoidable by providing such cylinder-shaped reflecting members. Without being limited to the above-stated method, the cylinder 9 may be mounted on the board as an independent component for example. Further, since the flatness of the bonding pad 3′ for mounting of the semiconductor laser chip is considerably better than that of the countersunk hole, it becomes possible to suppress dispersion in optical characteristics due to inclination of chips.

### Fifth Embodiment

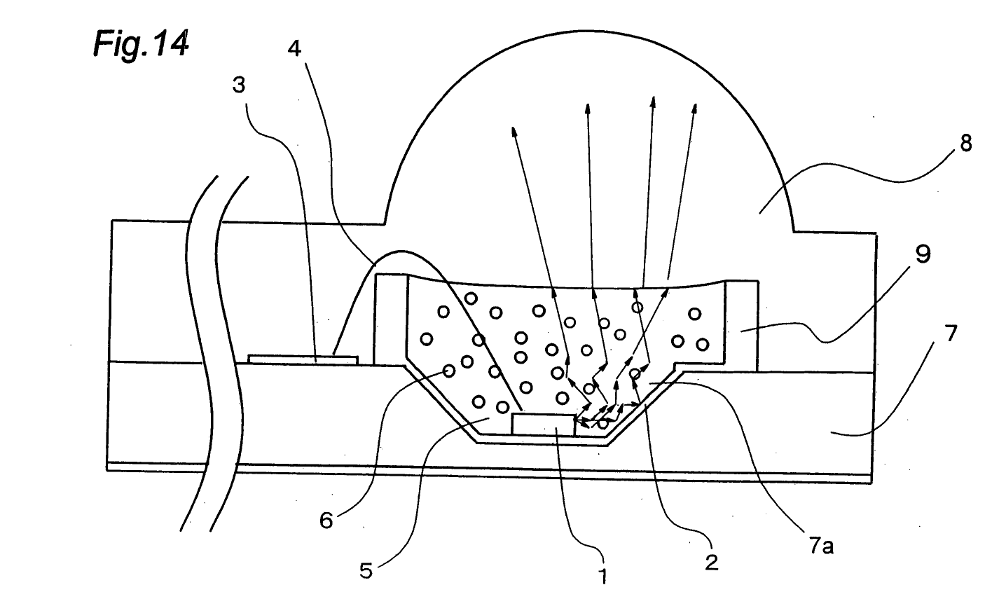

FIG. 14 is a cross sectional view showing the structure of an optical module as an example of a light source apparatus in a fifth embodiment of the present invention. Description is hereinbelow given of the optical module of the fifth embodiment. The optical module in the fifth embodiment is of structure having both the countersunk hole 7a of the optical module in the first embodiment and the cylinder 9 of the optical module in the fourth embodiment. Component members identical to those of the optical module in the first embodiment are denoted by identical reference numerals, and description thereof is omitted.

In the optical mode in the fifth embodiment, the largest effect of having both the countersunk hole 7a and the cylinder 9 is to be able to obtain the path length L longer than that in the optical modules in the first and fourth embodiments. The depth of the countersunk hole 7a is 0.3 mm, the height of the cylinder is 0.5 mm, the internal diameter is 1.6 mm, and the size and the position of the luminous point of the semiconductor laser chip 1 are identical to those in the first and fourth embodiments. Moreover, the oscillation wavelength of the semiconductor laser chip 1 is 890 nm. The path length obtained by the calculation method in the fourth embodiment is 0.9 mm. In this case, optimizing the structure of the light scattering region 5 makes it possible to increase the apparent source size immediately after light passes the light scattering region 5 up to about 1.8 mm. However, since the internal diameter of the cylinder 9 is 1.6 mm, the actual source size is limited to this value.

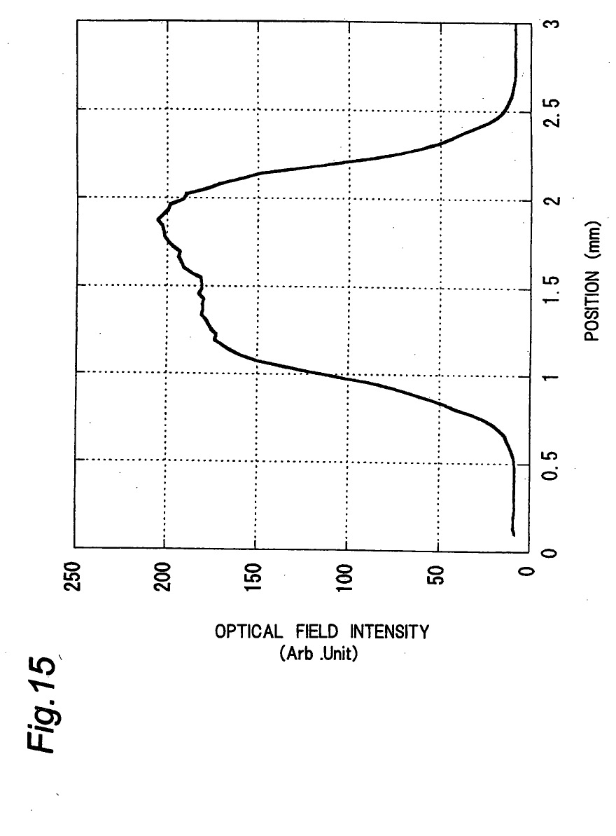

FIG. 15 shows an actual light distribution before the epoxy lens 8 of the aforementioned optical module is formed, the light distribution being taken by a CCD camera and being subjected to peak value analysis. A vertical axis represents a peak value (arbitrary scales), while a horizontal axis represents a width (mm). Thus, it was confirmed that light was distributed over a width of almost 1.6 mm, its shape was rectangle, and light distribution density was almost even. It is to be noted that in FIG. 15, data less than a peak value 10 is noise of the CCD camera and is not a laser light distribution.

### Sixth Embodiment

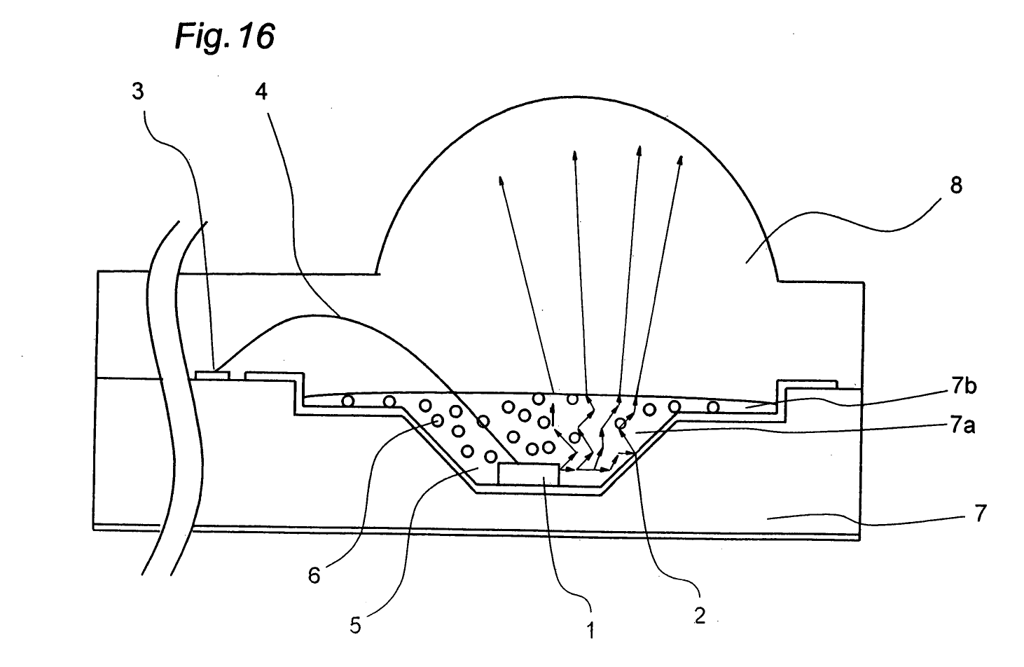

FIG. 16 is a cross sectional view showing the structure of an optical module as an example of a light source apparatus in a sixth embodiment of the present invention. Description is hereinbelow given of the optical module of the sixth embodiment. The optical module in the sixth embodiment is composed of, as shown in FIG. 16, a countersunk hole 7a on the board 7, and a reservoir section 7b which is disposed in the state of being connected upward from the countersunk hole 7a and which has a discrete diameter. The light scattering region 5 is designed to be formed up to the middle of the reservoir section 7b. In the countersunk hole 7a, the diameter of the bottom surface is 0.7 mm, the angle of gradient of the inclined surface is 45 degrees, and the depth is 0.25 mm. The reservoir section 7b is 2.1 mm in diameter and 0.1 mm in depth. The light scattering region 5 is designed so as to be formed in a region extending from the bottom surface of the countersunk hole 7a to the height of 0.28 mm, and the density of the light scattering particles 6 is adjusted so as to set the transport optical depth <n> to be <n>=4.

Laser light emitted from the semiconductor laser chip 1 passes the light scattering region 5, and then is radiated to space through the epoxy lens 8.

In the light source apparatus of the present invention, a base material (silicon gel) forming the light scattering region 5 is doped with light scattering particles 6, and after being stirred, the resin is filled in the countersunk hole, by which the light scattering region 5 are formed. The silicon gel, which is a typical thermosetting resin, is a paste with high viscosity (0.3 to 4 Pa.s), and the viscosity is further enhanced by doping the light scattering particles. Though the silicon gel is thermosetting resin, it is slowly hardened even in room temperature environments, and therefore the viscosity increases by lapse of time and its hardening rate is changed by humidity. Further, the viscosity is largely affected by temperature change during operation. In a typical manufacturing process, a method called potting is adopted. In this embodiment, a light scattering member (mixture of silicon gel and light scattering particles) encapsulated in a syringe (injection cylinder) is delivered at a constant pressure and filled in the countersunk hole 7a. However, the viscosity change as described above causes considerable change in its delivery amount. We confirmed that in an actual operating environment, the delivery amount of the light scattering member fluctuated in the range of 0.6 to 1.4 times as large as a specified amount. In this sixth embodiment, the distance from the bottom surface of the countersunk hole 7a to the top surface of the light scattering region 5 changes in the range of 0.25 mm to 0.32 mm. In this sixth embodiment, the light scattering member will not flow over from the reservoir section 7b. In terms of the transport optical depth, the fluctuation of the thickness is equivalent to <n>=4.0±0.5. As is clear from FIG. 3, this level of change in the transport optical depth will not impart large fluctuation to the source size. More particularly, in this embodiment, the fluctuation of the paste amount is absorbed by the reservoir section 7b so as to suppress the fluctuation of the thickness of the light scattering region 5 to a small level.

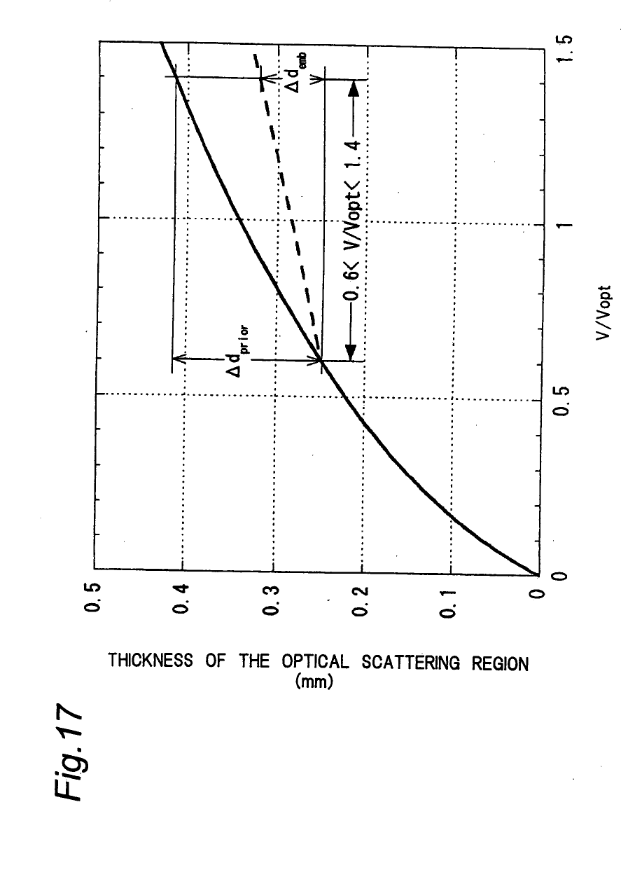

FIG. 17 is a view showing fluctuation of the thickness of a light scattering region in the optical module in the sixth embodiment. In FIG. 17, a horizontal axis represents V/Vopt, while a vertical axis represents a thickness (mm) of the light scattering region (silicon gel). Herein, Vopt denotes a specified delivery amount (optimum delivery amount) of the silicon gel encapsulated in a syringe (injection cylinder), and V denotes a volume of the silicon gel actually delivered. A broken line in FIG. 17 represents a range of thickness fluctuation of the light scattering region 5 in the optical module. A solid line in FIG. 17 represents a range of thickness fluctuation of the light scattering region 5 in the case where only the countersunk hole 7a (0.5 mm deep) is provided. In this case, in terms of the transport optical depth, the thickness fluctuation is equivalent to changes of <n>=4.0±1.2. As shown in FIG. 3, the largeness of the change in the transport optical depth <n> decreases the source size from its maximum value. If, for suppressing the thickness fluctuation of the light scattering region 5, the countersunk hole 7a is made as shallow as, for example, about 0.3 mm, then the light scattering member may flow over from the countersunk hole 7a as the case may be. In such a case, adhesion between the epoxy lens 8 which eventually constitutes a lens and the glass epoxy board 7 is extremely deteriorated, as a result of which the apparatus may fail to satisfy strength specifications as a commercial product. Moreover, “0.6<V/Vopt<1.4” shown in FIG. 17 is set based on the fact that in an actual operating environment, a delivery amount V fluctuates in the range of 0.6 to 1.4 times as large as a specified amount, in which V/Vopt corresponding region is set at 0.6 or more and 1.4 or less. In the range of 0.6<V/Vopt<1.4 in which volumes actually fluctuated, a depth change amount of the silicon gel in the optical module of conventional structure is expressed by Δdprior, while a depth change amount of the silicon gel in the optical module having the reservoir section 7b of the sixth embodiment is expressed by Δdemb. As is clear from FIG. 17, in the range of 0.6<V/Vopt<1.4, Δdemb<Δdprior can be satisfied, proving that providing the reservoir section 7b allows the depth fluctuation to be decreased with respect to the volume fluctuation.

In the sixth embodiment, the reservoir section 7b is provided as a resin reservoir for the light scattering member, which implements the effects such as control of the transport optical depth in the light scattering region 5 and prevention of product failure due to overflow of the light scattering member.

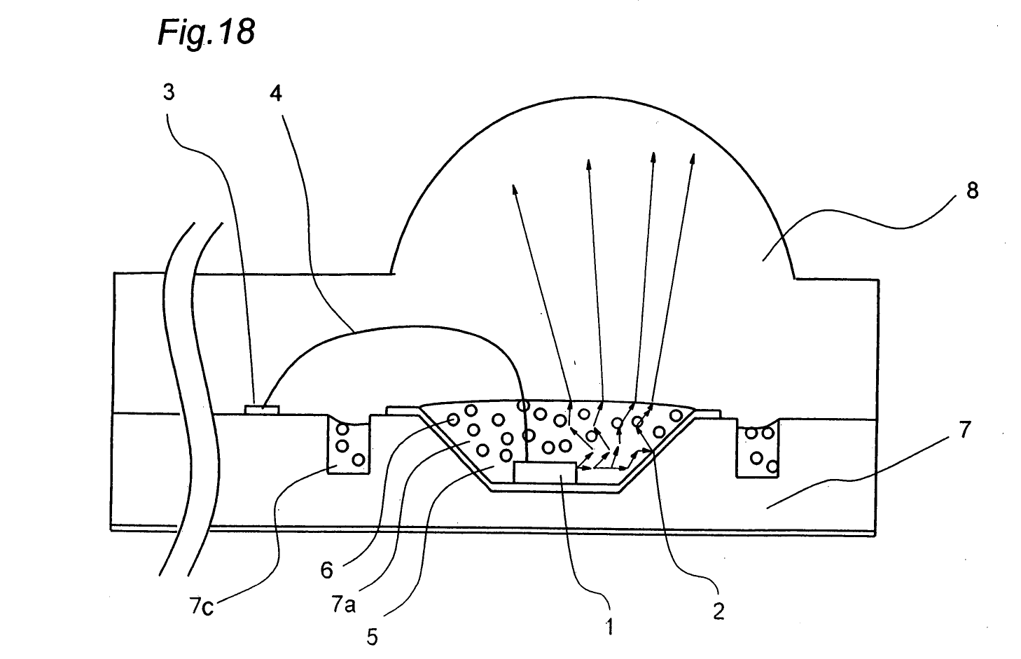

FIG. 18 shows a reservoir section of the light scattering member provided in another form. The reservoir section 7c shown in FIG. 18 is a circular groove having an almost rectangle cross section provided on the outer periphery of the countersunk hole 7a. In this example, the light scattering member flowed over from the countersunk hole 7a is stored in the reservoir section 7c provided in an outer periphery portion of the countersunk hole 7a, and is prevented from running away therefrom, making it possible to avoid the problem of adhesion failure from occurring. Without being limited to this embodiment form, the reservoir section 7c may be formed into a square shape by milling, or the cylinder 9 may also function as the reservoir section 7c as shown in FIG. 14.

As described above, in the first to sixth embodiments, a silicon gel is used as the base material forming the light scattering region. This is because the silicon gel is high in heat resistance and low in rigidity, which makes the silicon gel suitable as a coating of the semiconductor device. However, since the asymmetry factor g is determined based on difference in index of refraction between the base material and the light scattering particles (or a ratio of refractive index based on the base material), it is naturally understood that the base material combined with the light scattering particles is not limited to the silicon gel but other materials such as polyimide and polymethyl methacrylate (PMMA) may be used as the base material either.

### Seventh Embodiment

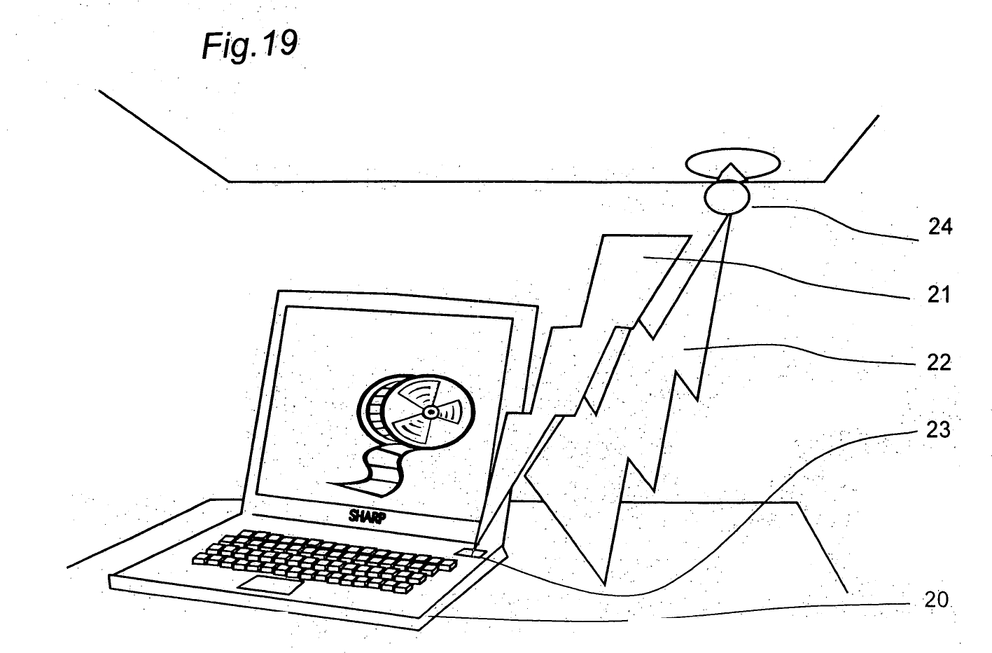

FIG. 19 is a schematic view showing the structure of an optical wireless communication system as an example of an optical communication apparatus in a seventh embodiment of the present invention. Description is hereinbelow given of the case where the light source apparatus of the present invention is applied to the system.

In this optical wireless communication system, an optical transceiver 23 including the optical module of the fifth embodiment shown in FIG. 14 is incorporated in a personal computer 20 exemplifying information equipment. The transceiver exchanges optical signals 21, 22 with a base station 24 installed in the ceiling. Maximum radiation intensity of light which is allowed to be radiated to space in the range of IEC60825-1 (Amendment 2) class 1 is approx. 400 mW/sr per hour, which is approx. 60 times as high as the intensity of a typical semiconductor laser device having the same oscillation wavelength. Applying the light source apparatus of the present invention to the optical wireless communication system makes it possible to increase a communication distance about 8 times as long as the communication distance of the typical semiconductor laser. This makes it possible to apply the optical wireless communication which has been limited to adjacent equipment so far to communication between distant locations such as the ceiling and the desk as shown in this seventh embodiment.

In the seventh embodiment, description has been given of the optical wireless communication system which establishes communication between the personal computer 20 incorporating the optical transceiver 23 and the base station 24 installed in the ceiling. However, the optical wireless communication system is not limited to the one described above. The optical communication apparatus of the present invention may be applied to an optical wireless communication system which establishes optical communication between electronic equipments such as information equipments.

Further, in the first to the fifth embodiments, description has been given of an eye-safe light source apparatus using a single narrow-stripe high-power semiconductor laser as a semiconductor light-emitting device. However, the semiconductor light-emitting device having upper hand in photon-electron converting efficiency of LEDs is not limited thereto, and therefore this invention may also be applied to light source apparatuses using various light source devices with different temporal and spatial coherence such as array lasers having a plurality of strips, broad-area lasers and SLDs. The present invention is particularly effective for light sources whose light emitting surface size (a mean size of height and width) is 150 μm or less. The light sources with a size of 150 μm or less are treated equally with point sources as per safety standards so that they are subject to severe radiation intensity regulations. Applying the effect of increasing the source size in the present invention to these light sources makes it possible to provide semiconductor light source apparatuses which offers exceedingly enhanced safety regarding eyes. To light emitting devices emitting light having broad wave lengths such as SLD, the present invention may be applied using the peak wavelength thereof.

### Eighth Embodiment

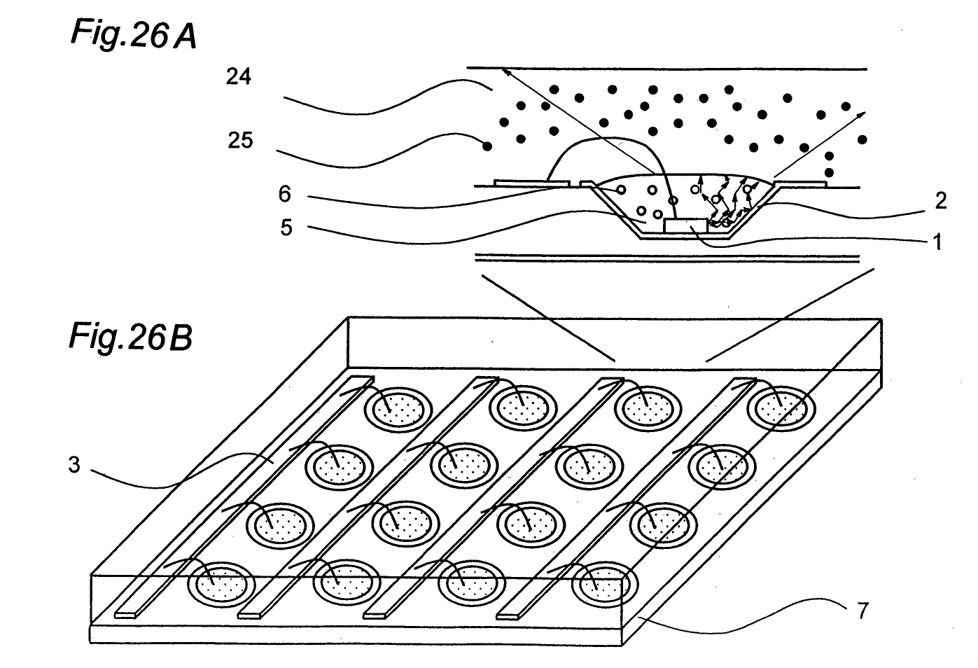

Description is given of a lighting system and an optical communication system using a light source apparatus in an eighth embodiment of the present invention. FIG. 26 is a schematic view showing a lighting system and an optical communication system using a blue semiconductor laser device (wavelength band of 400 nm), in which FIG. 26B is a perspective view showing the overall outline while FIG. 26A is a detail view showing a light source single unit described in the first to sixth embodiments.

As shown in FIGS. 26A and 26B, a semiconductor laser chip 1 disposed inside an arrayed metal reflecting section 2 provided on a highly thermal conductive glass epoxy board 7 is surrounded with light scattering particles 6 and a base material of a light scattering region 5 as with the previous embodiments.

Styrene particles are used as the light scattering particles 6 herein. The styrene particles is high in sphericity and therefore the particle size is easy to control, which makes them suitable for use in the eighth embodiment. As the base material, silicon gel is used as is the case with the first to the sixth embodiments. Each index of refraction is reduced as the wavelength of the laser is shortened, and its rate of change in index of refraction is almost the same in both the styrene particles and the silicon gel. Therefore, the ratio of refractive index is almost unchanged, and therefore in this embodiment, the size of the light scattering particles is decreased by the percentage of the shortened wavelength so as to allow maximization of the source size with low optical loss as is the case with the first to the sixth embodiments. Since the laser oscillation wavelength in this embodiment is approx. 400 nm, the optimum particle size of light scattering particles is 0.06 to 1.0 times as large as the wavelength as with the previous embodiment. Moreover, setting the range of an obtained product g·<n> at 2 to 40 allows individual source sizes to be increased and optical loss to be reduced.

Description is now given of the operation of the lighting system and the optical communication system. Each laser is electrically connected to each comb-shaped electrode pattern 3 provided on a board 7, and the lasers oscillate by one row upon application of current. In the eighth embodiment, as shown in the detail view, light emitted from the semiconductor laser chip 1 passes the light scattering region 5, and then comes incident to a resin layer 24 including phosphors 25 (unshown in FIG. 26B). The phosphors 25 are made of indium nitride (InN) compound semiconductor particles, their sizes are approx. 5 nm, 6 nm and 13 nm. These phosphors 25 are excited by light with a wavelength of 400 nm, and emit blue, green and red fluorescent light respectively. As a result, the system can be used as a white-color lighting system. It is to be noted that these phosphors are sufficiently small with respect to the wavelength, and therefore light scattering will not occur. Light scattering occurs in the region with the presence of the light scattering particles 6, and the source size is optimized so as to be maximized in this region. According to the eight embodiment, increase in source size is easily conducted, which makes it possible to design the lighting system itself to be thin-shaped. Moreover, in the case where the number of semiconductor laser chips 1 is identical, unevenness in strength and illumination intensity is suppressed as the lighting system, allowing its upsizing.

Such thin-shaped lighting systems capable of upsizing are preferably used as back lights of liquid crystal displays. Using this lighting system makes it possible to obtain back lights which are thinner than conventional fluorescent lamps and allows implementation of beautiful displays free from irregular colors as described before. Moreover, compared to the back lights using light-emitting diodes which are under development in recent years, the lighting system in the present embodiment is a back light source which is small in the degradation amount of optical field in a certain operating time and good in long-term reliability.

### Ninth Embodiment

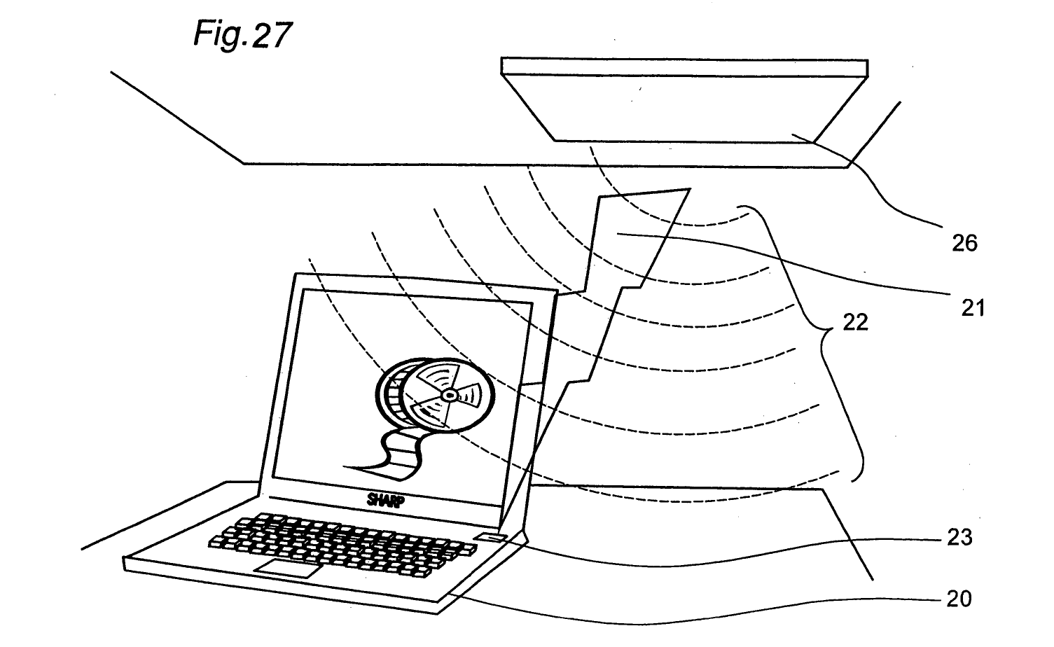

FIG. 27 is a schematic view showing a lighting system 26 having an optical communication function using a light source apparatus in a ninth embodiment of the present invention. The ninth embodiment is an application example of the eighth embodiment. In the lighting system in the above-described eighth embodiment, signals are modulated and superposed on current applied to each semiconductor laser chip so as to form a lighting system-cum-optical communication apparatus.

A modulated visible light signal is distributed over the entire room from an optical transparent casing in which a lighting system of FIG. 26 is housed. In the case of visible light rays, the radiation intensity of light which can be radiated to space may be set larger than that of infrared rays, resulting in increase in communication available distance. Moreover, in the case where the system is used inside the room where only illumination light is present, it becomes possible to control background light which affects reception characteristics, thereby allowing further enhancement of receiver sensitivity. Further, compared to the case of using a light-emitting diode, the semiconductor laser is good in modulation characteristics, which is advantageous in terms of communication speed.

The light source apparatus in the present invention is installable in the places which have the possibility to be viewed by people. For example, mounting the apparatus on optical wireless communication apparatuses and the like, which are impossible to be used in the past, opens the way for high-speed optical communication which could not be realized by light-emitting diodes. In addition, the light source apparatus and the optical communication apparatus of the present invention are suitable for application to the systems involving laser light which potentially comes incident to human eyes, such as high-speed optical communication systems, laser pointers, laser projectors, and lighting systems with phosphors and a blue-violet light source being combined.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A light source apparatus, comprising a light scattering region containing light scattering particles disposed in a part of a region extending from a semiconductor light-emitting device to an external space where radiation light radiated from the semiconductor light-emitting device passes, wherein
a product g·<n> of an asymmetry factor g of the light scattering particles and a transport optical depth <n> of the light scattering region satisfies a following condition:
2≦g·<n>≦40

2. The light source apparatus as defined in claim 1, wherein a product g·<n> of an asymmetry factor g of the light scattering particles and the transport optical depth <n> of the light scattering region satisfies a following condition:
2≦g·<n>≦15

3. The light source apparatus as defined in claim 1, wherein when an albedo γ of the light scattering particles is 0<γ<1, the asymmetry factor g of the light scattering particles satisfies a following condition:
$$g \leq 0.342 {( \frac{1}{γ} - 1 )}^{- 0.116}$$

4. The light source apparatus as defined in claim 1,
wherein
when an albedo γ of the light scattering particles is 0<γ<1, a product g·<n> of the asymmetry factor g of the light scattering particles and the transport optical depth <n> of the light scattering region satisfies a following condition:
$$2 \leq g \cdot 〈 n 〉 \leq 0.146 {( \frac{1}{γ} - 1 )}^{- 0.487}$$

5. The light source apparatus as defined in claim 1, wherein
when an albedo γ of the light scattering particles is 0<γ<1, a product g·<n> of the asymmetry factor g of the light scattering particles and the transport optical depth <n> of the light scattering region satisfies a following condition:
$$2 \leq g \cdot 〈 n 〉 \leq 0.110 {( \frac{1}{γ} - 1 )}^{- 0.487}$$

6. The light source apparatus as defined in claim 1, wherein
the transport optical depth <n> of the light scattering region satisfies a following condition:
3≦<n>≦20

7. The light source apparatus as defined in claim 1, wherein
the asymmetry factor g of the light scattering particles satisfies a following condition:
g<0.9

8. An optical communication apparatus using the light source apparatus as defined in claim 1.

9. A light source apparatus comprising:
a semiconductor light-emitting device;
a light scattering region containing light scattering particles in a part of a region extending from the semiconductor light-emitting device to an external space where radiation light radiated from the semiconductor light-emitting device passes; and
a reservoir section capable of storing a light scattering material which forms the light scattering region.

10. A light source apparatus, comprising a light scattering region containing light scattering particles disposed in a part of a region extending from a semiconductor light-emitting device to an external space where radiation light radiated from the semiconductor light-emitting device passes, wherein
the light scattering particles contain particles whose diameter is not less than 0.67 times and not more than 1.0 times as large as a central wavelength of the radiation light.

11. The light source apparatus as defined in claim 10, wherein
a difference in refractive index between the light scattering particles and a base material forming the light scattering region is not less than 0.025 and not more than 0.043 times as large as the refractive index of the base material, and a ratio of volumes of mixing of the scattering particles to the base material is not less than 25%.

12. The light source apparatus as defined in claim 10, wherein
a difference in refractive index between the light scattering particles and a base material forming the light scattering region is not less than 0.043 times as large as the refractive index of the base material, and a ratio of volumes of mixing of the scattering particles to the base material is less than 25%.

13. The light source apparatus as defined in claim 10, wherein
the light scattering particles are made of any one of polymethyl styrene, polymethyl methacrylate and polybutyl methacrylate.

14. The light source apparatus as defined in claim 1, wherein
the asymmetry factor g of the light scattering particles is obtained from a following formula:
$$g = {\int }_{0}^{∞} p ( r ) {g}_{i} ( r ) ⅆ r ,$$
wherein p(r) represents particle size distribution probability of the light scattering particles and gᵢ(r) represents the asymmetry factor when the particle size of the light scattering particles is r.

15. The light source apparatus as defined in claim 1, wherein
the light scattering region is composed of a plurality of light scattering particles, and
the asymmetry factor g of the light scattering particles is obtained from following formulas:
$$\begin{matrix}g = {\sum }_{j = 1}^{n} {f}_{i} {\int }_{0}^{∞} {p}_{j} ( r ) {g}_{ji} ( r ) ⅆ r ; and \\ {\sum }_{j = 1}^{n} {f}_{i} = 1 ,\end{matrix}$$
wherein fⱼ(j=1, . . . , n (n is an integer equal to or larger than 2)) represents a ratio of number of the light scattering particles, pⱼ(r) represents particle size distribution probability per light scattering particle, and gⱼᵢ(r) represents an asymmetry factor when the particle size of the light scattering particles is r.
